(19) United States
(12) Patent Application Publication
(10) Pub. No.: US 2017/0287297 A1
(43) Pub. Date: Oct. 5, 2017

(54) Security System for a Retail Environment

(71) Applicant: Aprium Tech Limited, London (GB)

(72) Inventors: Anthony Richard Hardie-Bick, London (GB); David Lee Sandbach, Brighton (GB)

(21) Appl. No.: 15/472,360

(22) Filed: Mar. 29, 2017

(30) Foreign Application Priority Data
Mar. 31, 2016 (GB) 16 05 411.6
Mar. 31, 2016 (GB) 16 05 415.7

(51) Int. Cl. G08B 13/24

(52) U.S. Cl. CPC G08B 13/246; G08B 13/242

(57) ABSTRACT

A security system for deployment within a retail environment is shown. First tags (108 to 112) are concealed within an item of merchandise. Each of these first tags is configured to transmit a first signal modulated to specify a unique first tag code in response to being energised at an exit gate. Second tags (113 to 117) are each independently attached to the merchandise and are configured to communication with mobile devices to facilitate the purchase of the items. A data communication apparatus (119) communicates with mobile devices and controls responses of an exit gate when detecting output signals from the first tags. User selected tags transmit second output signals to a mobile device in response to respective user interactions, with each for the second output signals being modulated by a unique second code. The mobile devices relay received second codes to the communication system. The communication system returns product data for selected second tags, including a graphical representation of each selected item. Mobile devices are configured to dynamically display graphical representations of selected items. In addition, they are configured to dynamically position the graphical representations in response to positional data identifying a relative position of each of the selected items and further communicate with the communication system to initiate a sale of a preferred item chosen from the displayed selected items. The data communication apparatus controls exit gates so as not to raise an alarm in response to detecting a respective first tag concealed within a purchased item.

### CROSS REFERENCE TO RELATED APPLICATIONS

This application claims priority from United Kingdom patent application Number 1605411.6 filed Mar. 31, 2016 and United Kingdom patent application number 1605415.7, filed Mar. 31, 2016, the entire disclosure of which are incorporated herein by reference in their entirety.

### BACKGROUND OF THE INVENTION

The present invention relates to a security system for deployment within a retail environment.

It is known to attach security tags to items of merchandise in retail environments. Traditionally, tags of this type are detected at an exit gate when an item has not been purchased.

Proposals have also been put forward for using security tags to assist with the actual purchasing of merchandise. Thus, a more sophisticated type of tag may be included that allows communication with a mobile phone that may in turn communicate with instore security systems for achieving an automated sale of the item. Further proposals have been put forward to the effect that the tag may automatically release when a sale has taken place. However, problems have been identified in terms of devising a tag that can be released easily when a sale has been made but at the same time achieves conventional security levels to prevent unauthorised removal. Further problems have been identified in that customers often express an initial interest in several items, not just one, and an appreciation has been made to the effect that, from a marketing perspective, it is useful to identify items that were nearly sold in addition to those that we actually sold.

### BRIEF SUMMARY OF THE INVENTION

A first aspect of the present invention provides a security system for deployment within a retail environment. The system facilitates the detection of unauthorised removal of items and in addition it facilities the automated sale of items which may then be removed without alerting the security system. To overcome problems associated with a single tag providing all of this functionality, a plurality of first tags, are provided with each being arranged to be concealed with an item of merchandise such that it is not visible to potential customers. The first tags are configured to transmit a first signal that is in turn modulated to specify a first tag code in response to being energized at an exit gate. Furthermore, second tags are provided and each second tag is independently attached to the items of merchandise at positions that are visible to potential customers. The second tags are configured to communicate with mobile devices to facilitate a purchase. Within the facility, a data communication apparatus is provided for communicating with mobile devices and controlling responses of the exit gate when detecting output signals from the first tags. The second tags are configured such that a user selects a tag which then transmits a second output signal modulated by a unique second code to a mobile device, in response to a user interaction. When a mobile device receives a second output signal, the mobile device relays the second code to the data communication apparatus. Upon receiving this code, the data communication apparatus initiates a procedure to facilitate a purchase of an item to which an interacted second tag has been attached, resulting in a sale being completed or a sale failing to be made. The data communication apparatus controls the exit gate so as not to be responsive to raise an alarm on detecting a respective first tag concealed within a purchased item. However, the exit gate will raise an alarm if a first concealed tag is detected when a respective second tag attached to the same item has not completed a sale.

The first tags may include radio frequency identification devices and in some applications, these devices may remain active after the item has been removed from the retail environment. In these circumstances, the device will have been detected at the exit gate but the communication apparatus is aware that the item has been purchased (based on receiving a second code) such that the alarm system is effectively disabled. However, in situations where concealed tags may create a privacy issue, it is possible for the communication device to control the exit gate in order to deactivate first concealed tags in items that have been purchased.

In a second aspect of the present invention, a security system is provided for deployment within a retail environment. The system includes a plurality of first tags for concealment within an item of merchandise for detection at an exit gate. In addition, there are provided a plurality of second tags, wherein each second tag is independently attached to an item and is configured to communicate with mobile devices to facilitate a purchase of an item via a mobile device. A data communication apparatus communicates with mobile devices and controls responses of the exit gate when detecting output signals from the first tags. A plurality of user selected second tags transmit second output signals to a mobile device in response to respective user interactions, where each second output signal is modulated by a unique second code. The mobile device relays the received second codes to the communication system and the data communication system returns product data for the plurality of selected tags. Each product data includes a graphical representation of each selected item. The mobile device is configured to dynamically display each of these graphical representations of selected items. In addition, the mobile device dynamically positions the graphical representations in response to positional data identifying a relative position of each of the selected item to the mobile device. The mobile device is then configured to further communicate with the communication system to initiate a sale of a preferred item chosen from the displayed selected items.

In an embodiment, the positional data is derived from an evaluation of signal strengths of respective second output signals.

### BRIEF DESCRIPTION OF THE SEVERAL VIEWS OF THE DRAWINGS

FIG. 1 shows a retail environment, including tagged items having a first type of tag and a second type of tag, a customer's mobile device, an security server, an administration server and a payments server;

FIG. 2 details the first type of tag shown in FIG. 1;

FIG. 3 shows a schematic of the tag shown in FIG. 2;

FIG. 4 shows a view of the second type of tag shown in FIG. 1;

FIG. 5 shows another view of the second type of tag shown in FIG. 1;

FIG. 6 shows a schematic of the second type of tag shown in FIG. 1, including a memory;

FIG. 7 shows an alternative schematic of the second type of tag shown in FIG. 1;

FIG. 8 details the contents of the tag memory shown in FIG. 6, including tag instructions;

FIG. 9 details the tag instructions shown in FIG. 8, including a step of tag selection processing;

FIG. 10 details the step of tag selection processing shown in FIG. 9, including a step of associating with a mobile device;

FIG. 11 details the step of associating with a mobile device shown in FIG. 10;

FIG. 12 details components of the customer's mobile device shown in FIG. 1, including a physical browser app, an active list of connected tags and a touchscreen;

FIG. 13 details steps performed by the physical browser app shown in FIG. 12, including a step of processing an active list of connected tags;

FIG. 14 details the active list of connected tags shown in FIG. 12;

FIG. 15 details the step of processing an active list of connected tags, shown in FIG. 13, including a step of updating the touchscreen shown in FIG. 12 and a step of processing association gestures;

FIG. 16 shows the effect of the step of updating the touchscreen shown in FIG. 15;

FIG. 17 shows another effect of the step of updating the touchscreen shown in FIG. 15;

FIG. 18 shows a further effect of the step of updating the touchscreen shown in FIG. 15;

FIG. 19 details the step of processing association gestures shown in FIG. 15, including a step of purchase processing;

FIG. 20 details the step of purchase processing shown in FIG. 19;

FIG. 21 details components of the administration server shown in FIG. 1, including a server unit memory;

FIG. 22 shows steps performed to initialise the administration server shown in FIG. 21, including a step of running administration instructions;

FIG. 23 details the server unit memory shown in FIG. 21;

FIG. 24 details the step of running administration instructions shown in FIG. 22;

FIG. 25 shows components of the security server shown in FIG. 1, including security instructions;

FIG. 26 details the security instructions shown in FIG. 25, including a process of deactivating a tag, a process of scanning exits, and a process of performing an inventory scan;

FIG. 27 details the process of deactivating a tag shown in FIG. 26;

FIG. 28 details the process of scanning exits shown in FIG. 26;

FIG. 29 details the process of performing an inventory scan shown in FIG. 26; and

FIG. 30 summarises operations performed with the mobile device shown in FIG. 1.

### DETAILED DESCRIPTION OF EXAMPLE EMBODIMENTS

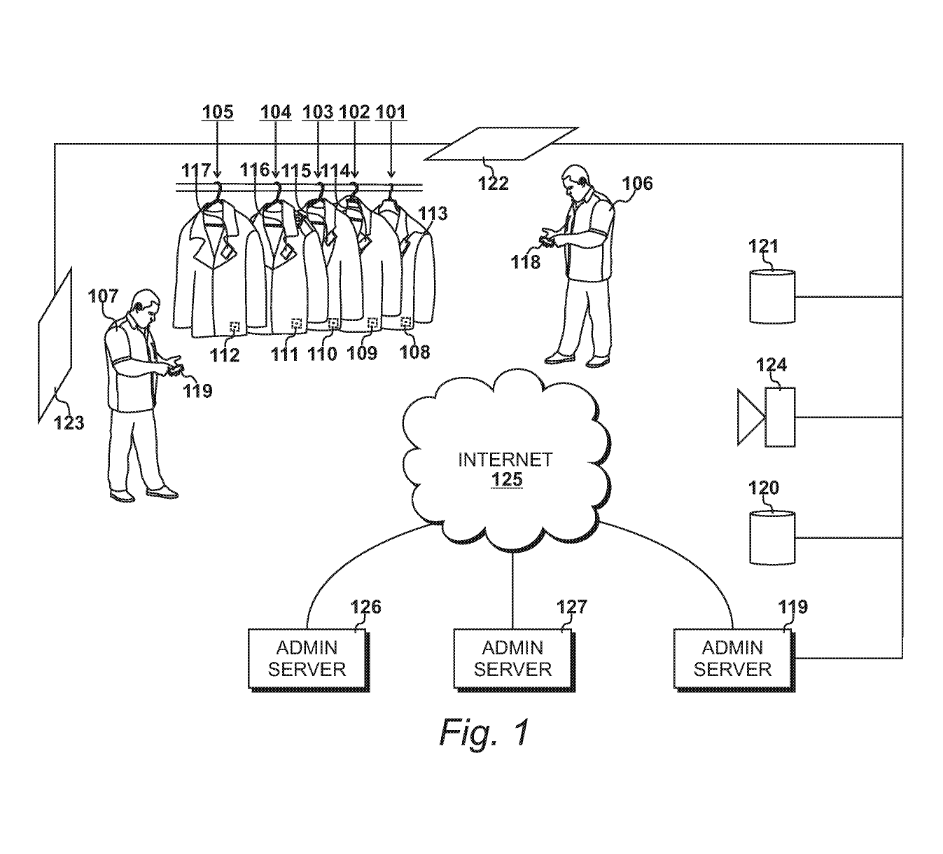

### FIG. 1

A retail environment is shown in FIG. 1. Several physical items 101 to 105 are on display to customers 106 and 107. The retail environment is a part of a clothing store, and the items 101 to 105 are items of apparel. The first physical item 101 includes a first type of tag 108 embedded within it. The second item 102 also includes a first type of tag 109 embedded within it. Items 103, 104 and 105 also include a first type of tag 110, 111 and 112 respectively. The first physical item 101 also includes a second type of tag 113 visibly attached to it. Similarly, items 102 to 105 include a second type of tag 114, 115, 116 and 117 respectively. Tags 108 to 112 of the first kind will be referred to as first tags, and tags 113 to 117 of the second kind will be referred to as second tags. Thus each physical item on sale in the retail environment of FIG. 1 has a first tag and second tag attached to it.

The first tags 108 to 112 are retained within the respective physical item, and cannot be easily removed. The second tags, 113 to 117 are highly visible and can be removed by a customer when appropriate. The first customer 108 has a mobile device 118 which is used to facilitate browsing of the items 101 to 105, followed by an optional purchase. The mobile device 118 is a smartphone 118, although other types of mobile device may be used, including a mobile device specifically designed for the purpose. However, the availability of low cost smartphones makes these the preferred mobile device for use in this environment.

The second customer 107 also has a smartphone 119, which is used similarly. It will be appreciated that a typical retail environment may include hundreds or thousands of physical items tagged as described.

The retail environment includes a security system 119 to 124, comprising a security server 119 connected to a first exit scanner 120 and a second exit scanner 121. Exit scanners 120 and 121 scan exits of the retail environment, identifying the presence of any first tags 108 to 112. This enables identification of the presence of items 101 to 105 near an exit. The scanner may also be able to determine direction of movement of a first tag 108, so that movement of an item 101 out of the retail environment can be identified. The security server 119 is further connected to inventory scanners 122 and 123, which identify the presence and approximate location of items 101 to 105 in the retail environment. The inventory scanners 122 and 123 make it possible to perform stock-taking and checking, and to identify movements of items prior to purchase. An alarm 124 is activated if an unusual movement or disappearance of the respective item is observed, or if an item 101 is taken past an exit scanner 120 or 121 prior to purchase.

In order to disable the exit alarm 124 for an item 101 to 105, it is necessary for a customer 106 or 107 to purchase the item 101. Operation of the system will be described by way of example. The customer 106 activates an app on the smartphone 118 to facilitate item browsing. In an embodiment, the app may be activated automatically to run in the background, for example as a component of a payment application or other retail environment application.

The customer 106 then finds an item 101 to be of interest, and taps the smartphone 118 lightly against the second tag 113 of the first item 101. The second tag 113, now activated, communicates with the smartphone 118. The tag's communication includes transmission of a second tag code, which is then transmitted from the smartphone 118, via the Internet 125, to an administration server 126. The administration server 126 then looks up information about the item 101, and transmits this item-related information back to the smartphone 118, for display to the customer 106. During communication between a tag 113 and the customer's mobile device 118, a position-related parameter is measured. An example of such parameter to measure is the Received Signal Strength Indication (RSSI) of wireless signal. This position-related parameter is then used to update a visible indicator on each activated tag and the touchscreen of the mobile device 118, thereby facilitating real time visible update in response to movement of the customer's mobile device 118.

Subsequently, the customer indicates a preferred item by making an association gesture. As a result of this gesture, the customer 106 becomes associated with the item 101, and can now pay for the item using their smartphone if they wish. During payment, the administration server 126 directs smartphone communications to a payments server 127. After a successful payment has been made, the administration server 126 transmits identifying information for the first tag 108 to the security server 119. The security server then disables alarms for the first tag 108, so that the customer may exit the retail environment without activating the alarm 124. Furthermore, upon exit with a purchased item 101, the first tag 108 is permanently disabled by a transmission from an exit scanner 120 or 121, thereby alleviating customer concerns about tracking outside the retail environment. The customer may easily remove the second tag 113 from the item 101, and place it in a bin located in the retail environment. The customer may be given a discount if the second tag 113 is returned to the retail environment.

The first tag 108 facilitates inventory and theft-prevention. For example, the second tag 113 could be removed prior to purchase, but the item 101 retains the first tag 108, preventing it from being removed from the retail environment without setting off the alarm 124.

The second tags 113 to 117 enable purchases to be made, by acting as a bridge between customers' mobile devices 118 and 119 and the first tags 108 to 112 which are used for item identification by the security system 119 to 124. The second tags 113 to 117 are removable and reusable.

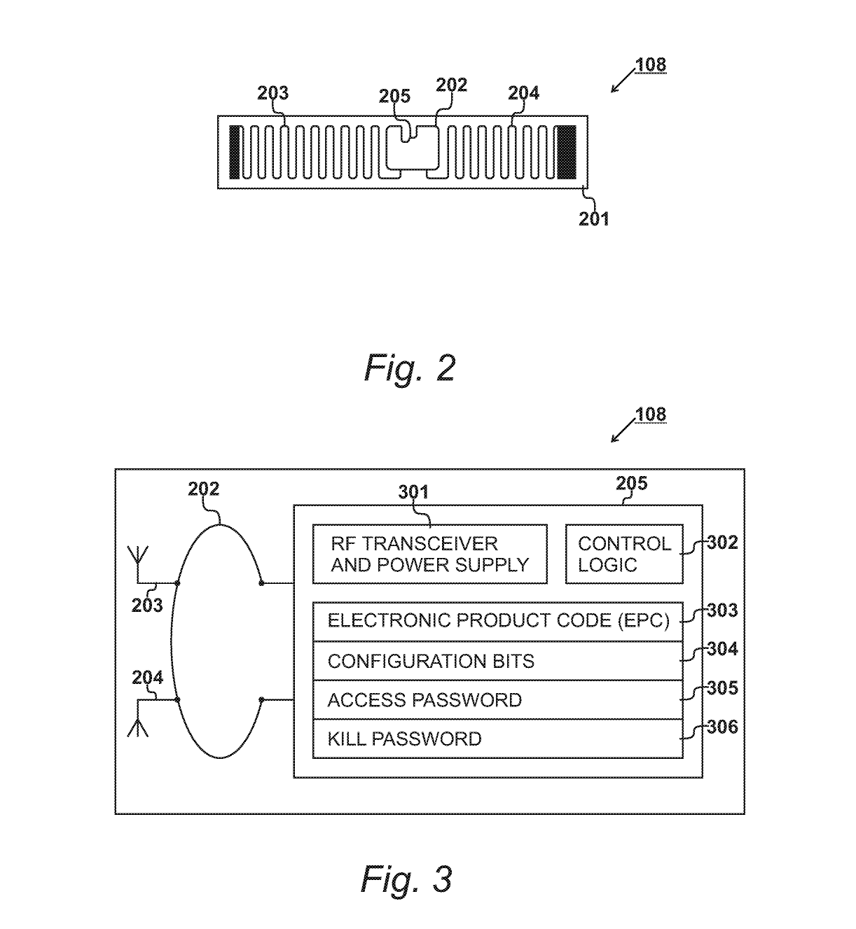

### FIG. 2

The first tag 108 shown in FIG. 1 is detailed in FIG. 2. The following description applies to the structure and functionality of the other first tags 109 to 112 of FIG. 1. In this example, first tag 108 is a passive RFID tag operating at a range of frequencies between 865 MHz and 928 MHz in the Industrial, Scientific and Medical (ISM) band. A suitable tag of the kind shown in FIG. 2 is the ALN-9710 available from Alien Technology Corporation, 18220 Butterfield Blvd., Morgan Hill, Calif. 95037, USA. The tag 108 comprises a flexible plastic substrate 201, upon which are printed a conductive ink pattern forming a resonant inductor 202, a first tuned antenna 203 and a second tuned antenna 204. Connections are made between the resonant inductor 202 and a Higgs™ 4 RFID chip 205, which is also available from Alien Technology™ at the aforementioned address. The RFID chip 205 is approximately 0.5 mm by 0.5 mm in area, and 0.1 mm thick, making it possible to mount the chip on a flexible substrate while maintaining a consistent electrical connection to the resonant inductor 205. The overall size of the RFID tag 108 is 45 mm by 15 mm. It is designed to be retained within an item, such as an item of apparel 101, and is cheap enough to be retained within the item, even after purchase. For example, the RFID tag 108 may be retained within the lining, seam or label of the item 101.

### FIG. 3

A schematic representation of the RFID tag 108 detailed in FIG. 2 is shown in FIG. 3. The RFID chip 205 includes a radio-frequency (RF) transceiver and power supply 301 connected to two antennas 203 and 204 via the resonant inductor 202. The RF transceiver and power supply 301 derives power from transmissions from the scanners 120, 121, 123 or 124 shown in FIG. 1, and facilitates reception of commands from a scanner, and transmission of data to a scanner using modulated backscatter in accordance with ISO-18000-6C, available from http://www.iso.org.

Commands received by radio transmissions from a scanner 120 to 123 are interpreted by a control logic circuit 302 enabling reading and, in some cases, writing of the RFID chip non-volatile registers. These include a 128-bit Electronic Product Code (EPC) 303, configuration bits 304, a 32-bit access password 305 and a 32-bit kill password 306. The EPC is a code that includes two parts: a first part describing the type of product, known as the Global Trade Item Number (GTIN), and a second part which is a unique serial number, different on every RFID chip and therefore unique to each item tagged with such a chip. In combination, these two parts are known as a Serialised GTIN, or SGTIN, and are unified according to the EPC Tag Data Standard, available at www.gs1.org/epc/tds. The EPC is associated with the item 101 in which the first tag 108 is embedded; and this association information is available to the administration server 126.

The configuration bits 304 determine operation of the chip. The access password 305 makes it possible to limit interactions with the RFID chip unless a scanner correctly supplies a matching password. The kill password 306 makes it possible for a scanner, such as the exit scanner 120, to permanently disable the RFID chip 108, by sending a kill command followed by the kill password to the RFID tag 108. The passwords 305 and 306 are stored securely on the administration server 126 shown in FIG. 1, and are only transmitted to the security server 119 after the item 101 has been purchased.

Communication with the RFID tag 108 is possible over distances of up to ten meters from the scanners 120 to 123. Systems are known in which the distance between a scanner 120 and a passive RFID tag 108 can be roughly estimated. A first known method uses the received signal strength (RSS) of the backscatter modulation from the RFID tag 108 to estimate distance. Such a method has a typical accuracy of about one meter, but is subject to variations in the alignment of the RFID tag, multi-path reflections and occlusions. Improved accuracy is obtained using spread spectrum techniques with widely available low cost UHF RFID tags 108 to 112, as described in “Spread-Spectrum Based Ranging of Passive UHF EPC RFID Tags” by Holger Arthaber et al. in IEEE Communications Letters, Vol. 19, No. 10, October 2015. Using the spread-spectrum method, distances can be more consistently estimated to an accuracy of about twenty-five centimetres. Ranging accuracy of one centimetre or less is possible using a hybrid Ultra Wide Band (UWB) UHF RFID tag as described in “Hybrid UHF/UWB Antenna for Passive Indoor Identification and Localization Systems” by Catarina C. Cruz et al, in IEEE Transactions on Antennas and Propagation, Vol. 61, No. 1, January 2013.

Such ranging methods enable systems as shown in FIG. 1 to identify first tag distances from scanners. Furthermore, the use of multiple scanners 120, 121, 123 and 124, facilitates localization of passive tags 108 to 112 in two or three dimensions, thereby making it possible to fully identify locations of items 101 to 105 in the retail environment, and obtain an inventory of them. It will be appreciated that RFID systems may become capable of higher spatial resolution than those currently commercially available, and the costs of such systems are likely to decrease.

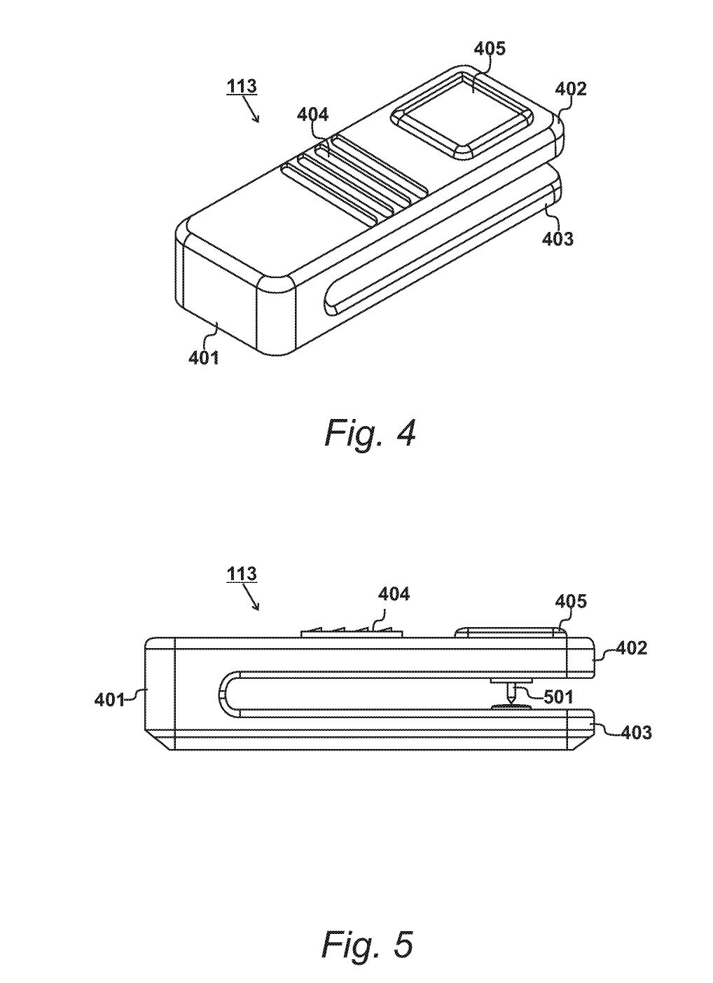

### FIG. 4

A problem with the RFID tags 108 to 112 shown in FIG. 1 and detailed in FIGS. 2 and 3, is that a standard smartphone 118 or 119 is unable to communicate directly with them. Therefore, there is no possibility of using an unmodified smartphone 118 as a point-of-sale (POS) device in an existing retail environment where items are equipped with passive RFID tags. This is unfortunate, as RFID tags are increasingly being used for the purposes of stock-taking, inventory management and theft-prevention.

The second type of tag 113 shown in FIG. 1 is detailed in FIG. 4. The tag 113 comprises a U-shaped plastic shell 401 having an upper section 402 and a lower section 403, between which part of the physical item 101 is located. The upper section 402 includes a release button 404 which is used to manually release the second tag 113 from the item 101 after it has been purchased. The upper section 402 also includes a visual indicator 405 which provides visual indications to the customer 106 during communications between the smartphone 118 and the second tag 113, thereby facilitating interactions between the customer 106 and the second tag 113.

### FIG. 5

The second tag 113 shown in FIG. 4 is shown in cross-section in FIG. 5. In this view a retention pin 501 can be seen, which passes through part of the item 101. Activation of the release button 404 results in retraction of the retention pin 501 so that the item 101 can be separated from the tag 113 without damage to either. It is possible for a customer to remove the tag 113 prior to purchase of the item 101. However, the customer will not be able to remove the item 101 from the retail environment without activating the alarm 124, due to the presence of the first tag 108, which is retained in the item 101. The first tag 108 is detectable by an exit scanner 120 or 121, resulting in activation of the alarm 124 upon detection of items that have not been purchased.

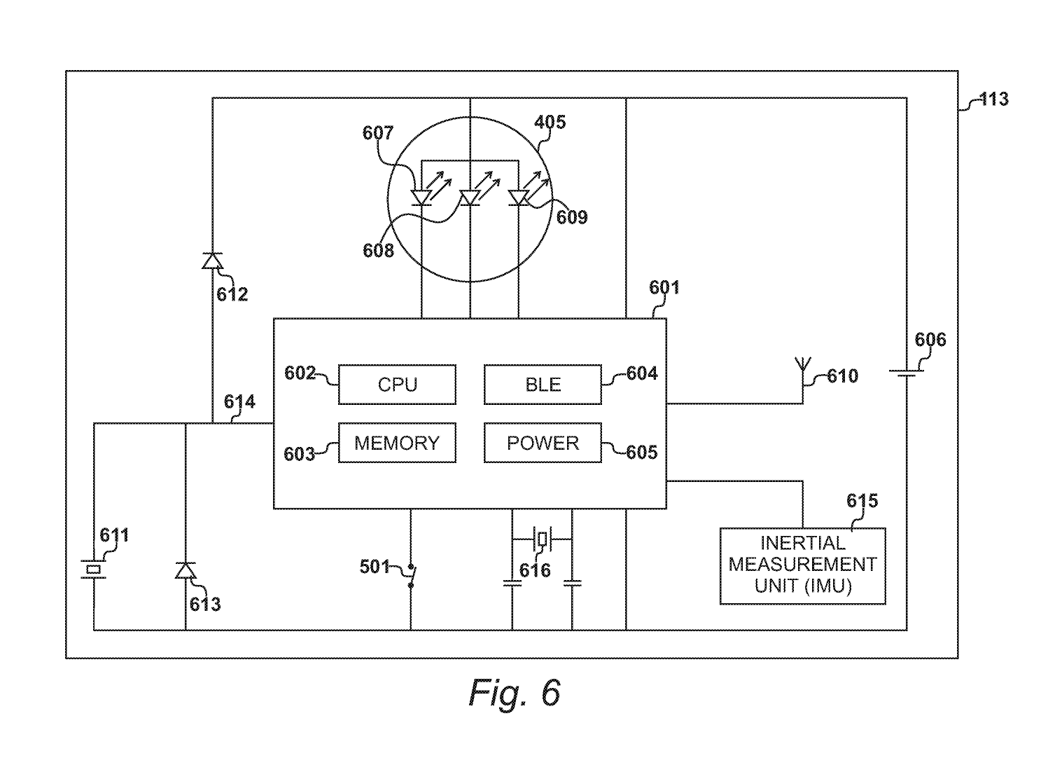

### FIG. 6

The electronic components of the second tag 113 are shown schematically in FIG. 6. A nRF52832 microcontroller 601 provides the majority of the circuitry. The nRF52832 is available from Nordic Semiconductor ASA, P.O. Box 436, Skoyen, 0213 Oslo, Norway. The microcontroller 601 includes a Central Processing Unit (CPU) 602, memory 603, a Bluetooth™ Low Energy (BLE) transceiver 604 and a power regulation and management circuit 605. The second tag 113 is powered by a 3.7V Lithium Ion coin cell 606.

The visual indicator 405 comprises a red Light-Emitting Diode (LED) 607, a green LED 608 and a blue LED 609. The LEDs 607 to 609 can be driven by the microcontroller 601 with a variable pulse width ratio, thereby obtaining any colour in the RGB gamut. The microcontroller's BLE circuit 604 is connected to an antenna 610, which facilitates transmission and reception with other BLE-equipped devices, including the smartphones 118 and 119 shown in FIG. 1.

A piezo-electric transducer 611 generates a brief alternating high voltage whenever an impact is imparted to the case 401 of the second tag 113, for example, an impact by a user's smartphone 118. This high voltage is limited by diodes 612 and 613 to prevent damage to the microcontroller 601. The limited piezo-electric signal is supplied to an input/output (I/O) pin 614 on the microcontroller 601, thereby providing a wake-up activation signal for the microcontroller 601. The microcontroller 601 is configured such that it normally consumes negligible power and is effectively switched off most of the time. When activated by the piezo-electric signal on the I/O pin 614, the microcontroller 601 starts operating, and initialises circuits, including internal oscillator circuits and the BLE circuit 604, for operation. Thereafter it executes microcontroller instructions.

After a while, depending upon interactions with a smartphone 118 or 119, the microcontroller 601 switches off again, until another impact occurs. In this way, the circuit of the second tag, as shown in FIG. 6, consumes negligible power until a user physically interacts with it. It will be appreciated that known BLE circuits are operated as continuously active BLE beacons, whereas the tag of FIG. 6 operates in a fundamentally different way. The tag 113 only becomes active for a limited time following a physical interaction. In an embodiment, an alternative physical interaction sensor may be used in a similar way to activate the tag.

The release pin 501 shown in FIG. 5 is connected to the microcontroller 601 in a normally-on configuration. The release pin 501 illustrates a simple, low-cost method of detecting removal of the second tag 113. When the release button 404 is pressed, the pin 501 breaks its connection temporarily, resulting in activation of the microcontroller 601 such that it can determine that a tag release has occurred or been attempted. If the release was not authorised as a result of payment for an item, various appropriate actions can be taken, including, but not limited to, activation of the piezo transducer 611 as an alarm, and a BLE broadcast transmission of an alarm signal. While advantageous in drawing attention to unauthorised removal of second tags, such alarms are not required for theft-prevention, due to the presence of the first type of tag 108, which is retained within the physical item 101.

An Inertial Measurement Unit (IMU) 615 provides monitoring of acceleration and rotation of the tag 113, so that gestures and other movements made with the tag can be detected. A quartz crystal 616 provides a stable frequency reference for the BLE transceiver 604 and instruction sequencing and timing of the CPU 602. Additional components such as decoupling capacitors, additional timing reference crystals and so on, are omitted, as these are standard components and are known in the art.

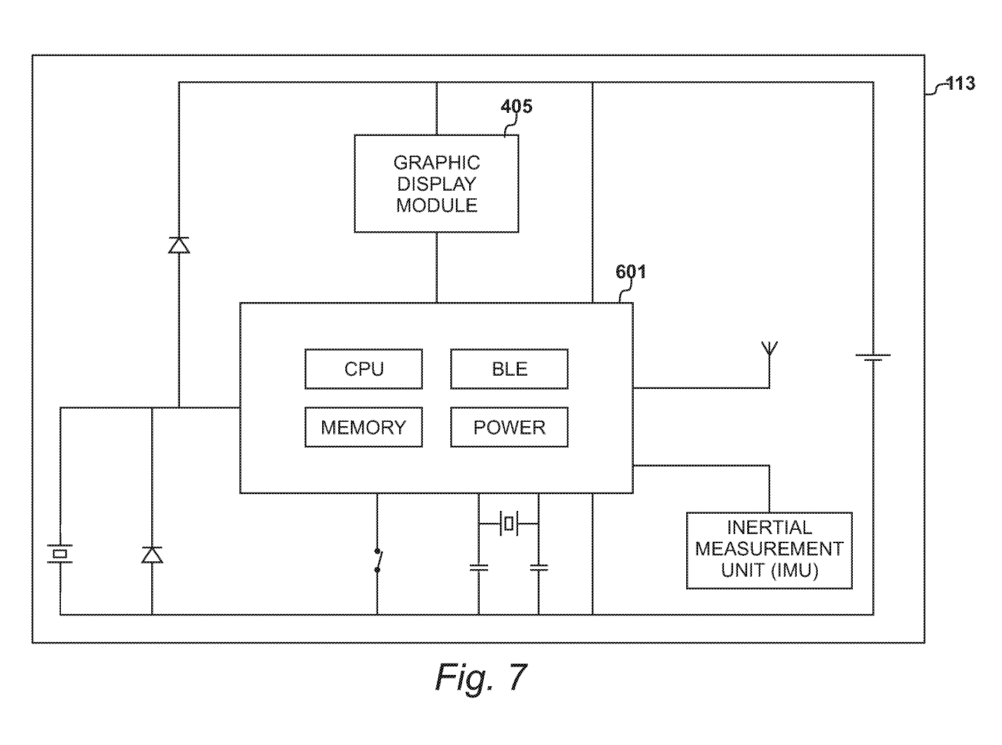

### FIG. 7

An alternative embodiment of the tag schematic shown in FIG. 6 is shown in FIG. 7. In the alternative circuit, the visual indicator 405 comprises a graphical display module utilising Electronic Ink (E-ink). Information about the item 101 can be displayed on the graphical display module 405, including pricing and so on. A known advantage of E-ink is that it consumes very little power, and information remains on display even when power consumption is reduced to almost zero, thereby making such a solution suitable for an embodiment of the second tag 113, as indicated in the schematic of FIG. 7.

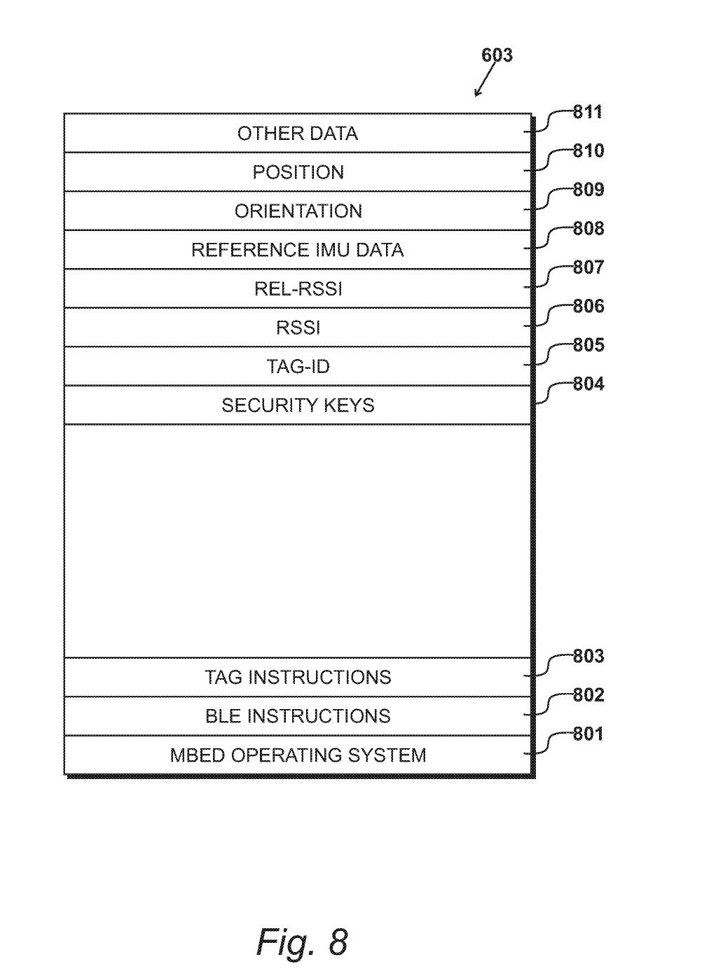

### FIG. 8

The functionality of the microcontroller 601 shown in FIG. 6 is largely determined by the contents of its memory 603, which are summarised in FIG. 8. The microcontroller memory 603 comprises two types: volatile static memory and non-volatile flash memory. However, in practice the volatile memory contents may often be considered as recently cached contents of flash memory, and it is sometimes helpful to ignore the distinction between these two types of memory for the purposes of clarity. It will be appreciated that instructions for the microcontroller are generally stored in flash memory, and loaded into static memory in small recently accessed chunks, to provide the most efficient usage of the available silicon.

An MBED™ Operating System (OS) 801 provides hardware abstraction and basic event management suitable for an embedded microcontroller. The MBED OS is available for download at https://github.com/ARMmbed/mbed-os. Bluetooth Low Energy (BLE) instructions 802 facilitate bidirectional wireless data communications between the second type of tag 113 and other BLE-equipped devices. Tag instructions 803 facilitate operation of the second type of tag 113 in order to communicate and interact with customers' smartphones 118 and 119.

Data in the tag memory 603 includes security keys 804, for maintaining secure communications over a BLE wireless connection. Tag data includes a tag identity code (TAG_ID) 805, a Received Signal Strength Indication (RSSI) field 806, and a relative Received Signal Strength Indication (REL_RSSI) field 807. Reference IMU data 808 includes data derived from the Inertial Measurement Unit (IMU) 615 shown in FIG. 6, including orientation derived from static acceleration due to gravity, and other data that defines the orientation, acceleration and/or position of the tag at the moment of activation. Orientation data 809 describes the current orientation of the tag 113. Position data 810 describes the current position of the tag 113, if known. Other data 811 includes temporary data used by the microcontroller 601.

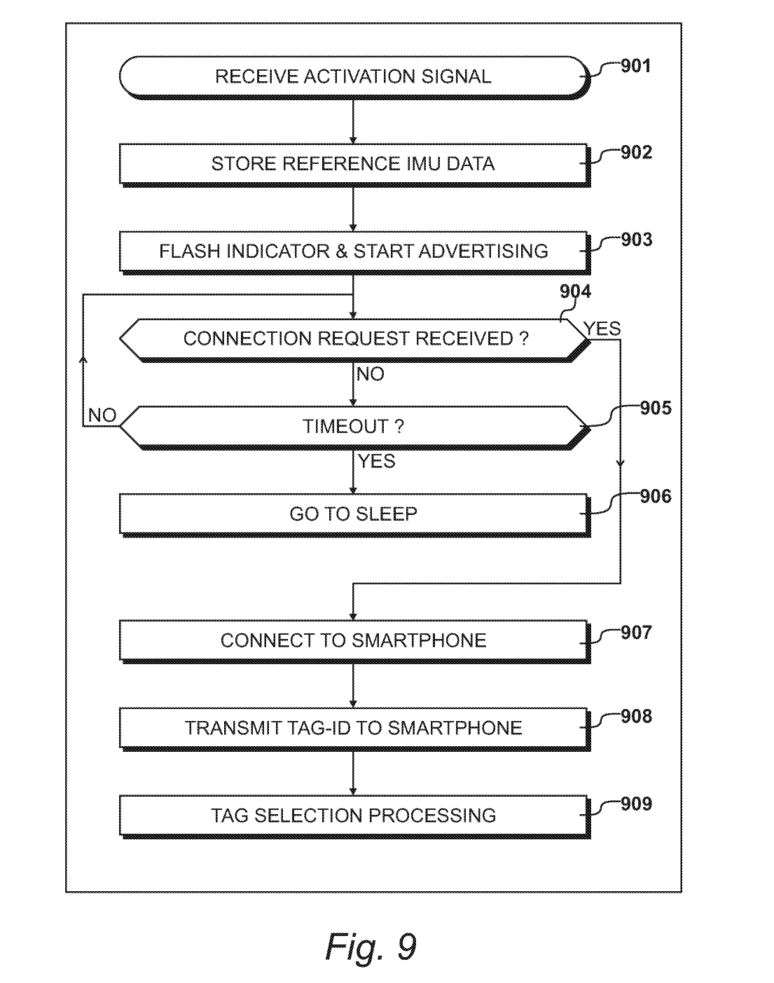

FIG. 9

Details of the tag instructions 803 shown in FIG. 8 are shown in FIG. 9. At step 901 a piezo-electric signal is received on the I/O pin 614 shown in FIG. 6, resulting in an activation signal 614 being supplied to the microcontroller 601. The activation signal typically results from a mutual impact between a customer's smartphone 118 and the second tag 113. This deliberate mutual impact occurs when the smartphone 118 is lightly tapped against the second tag 113. At this point, it remains to be determined whether or not the impact was a mutual impact with the smartphone 118 or simply an accidental impact that can be ignored.

At step 902 the reference IMU data 808 of the tag 113 is updated by acquiring data from the IMU 615. IMU data includes acceleration data due to static and or dynamic acceleration of the tag 113, as well as rotation data measured by one or more gyroscopes in the IMU 615.

At step 903 the visual indicator 405 is made to flash so that the customer 106 is able to see that the second tag 113 has been successfully activated. Simultaneously, the BLE module 604 is instructed to start transmitting advertising packets, thereby making the tag 113 connectible to the smartphone 118. The advertising packets include identification data such that the smartphone will recognise the tag as being a tag of the second type 113, and that it supports the operations to be described below. In an embodiment, the advertising data may include the TAG_ID 805.

At step 904 a question is asked as to whether a valid Bluetooth connection request has been received from a smartphone 118 or 119. If so, control is directed to steps 907 onwards, to establish a connection. Alternatively, a question is asked at step 905 as to whether a timeout has occurred. The timeout at step 905 is half a second, as a connection request from a smartphone 118 should be received as soon as it receives an advertising packet from the tag 113. Steps 904 and 905 repeat until either a valid connection request is received or a timeout occurs. In the event of a timeout, control is directed to step 906, where the microcontroller 601 is returned to a sleep state, thereby consuming very little power until another activation signal is generated by the piezo transducer 611.

At step 907 a connection is made with the smartphone 118 and at step 908 the TAG_ID 805 is transmitted to the smartphone 118. At step 909, tag selection processing is performed. It will be appreciated that, as a result of the steps of FIG. 9 being performed more than once, more than one second tag 113, 114 can be connected to the smartphone 118 at any particular time.

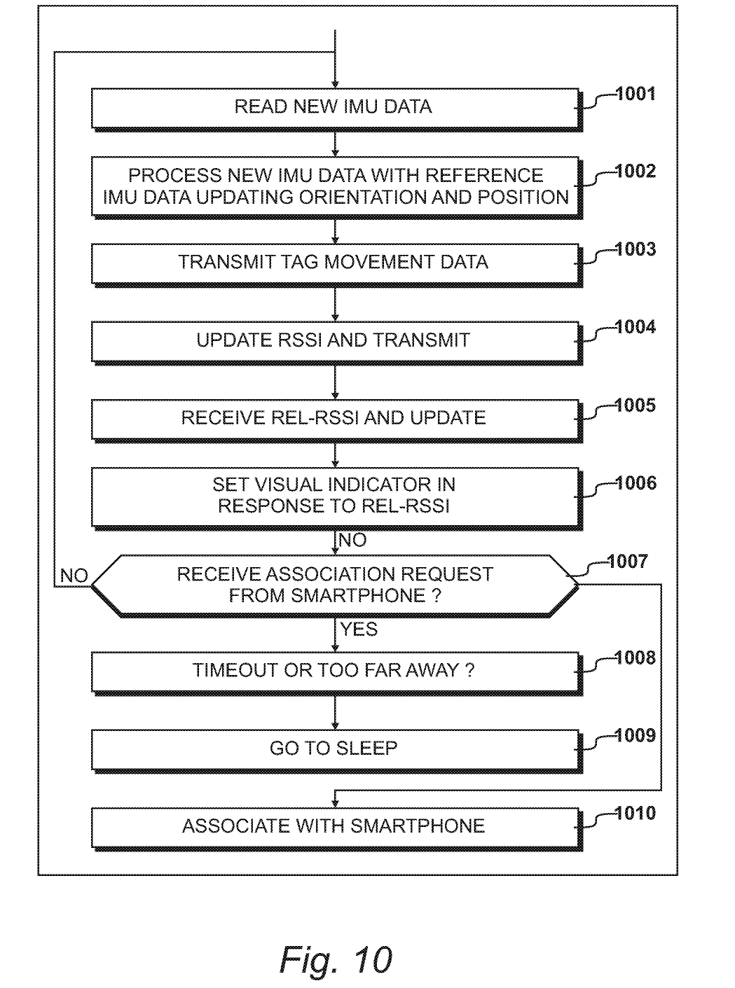

### FIG. 10

The step 909 of performing tag selection processing shown in FIG. 9, is detailed in FIG. 10. At step 1001 new acceleration and rotation data is obtained from the IMU 615. At step 1002 the new IMU data is processed to update the current orientation 809 and, if available, current position data 810. These are processed with the reference IMU data 808 in order to identify relative movement of the tag 113. The resulting movement data is transmitted to the smartphone 118 at step 1003.

At step 1004, the RSSI of the smartphone's Bluetooth signal is obtained from the BLE circuit 604 and the RSSI field 806 is updated. The RSSI value is then transmitted to the smartphone 118. It will be appreciated that measurement and transmission of RSSI data can be performed out of sequence in response to a request by the smartphone 118.

At step 1005, relative RSSI data is received from the smartphone 118 and the REL_RSSI field 807 is updated. At step 1006 the tag's visual indicator 405 is set in response to the updated REL_RSSI field 807. As a result, the visual indicator 405 generates its visual indication in response to changes in a relative RSSI value calculated by the smartphone 118, rather than a specific RSSI relating solely to the wireless connection between the connected tag 113 and the smartphone 118.

This has significance when the smartphone 118 is connected to more than one tag, such as tags 113 and 114. When more than one secondary tag 113, 114 has been connected to the smartphone 118, movement of the smartphone 118 between the two tags 113, 114 results in a clearer indication from their respective visual indicators 405 than would be the case if absolute or normalised RSSI 806 alone were used. The relative proximity of the smartphone 118 is indicated by the level of brightness of LEDs 405, thus aiding the interaction with the customer. This improves clarity of identification of a particular tag in relation to others that have been activated, and thereby makes selection of an individual tag more intuitive.

At step 1007 a question is asked as to whether an association request has been received from the connected smartphone 118. If not, control is directed to step 1008, where a timeout of one minute is applied. If a timeout has not occurred, control is directed back to step 1001. Alternatively, in the event of a timeout, or if the smartphone 118 has moved too far away, the microcontroller 601 is returned to a low power sleep state at step 1009. Alternatively, if an association request has been received, control is directed to step 1010, where the tag 113 is associated with the connected smartphone 118. It will be appreciated that the association is a specific state which occurs as a result of a specific deliberate intent by the customer 106 showing interest in a particular item 106. Furthermore, it is possible for a customer to be associated with more than one item at any one time.

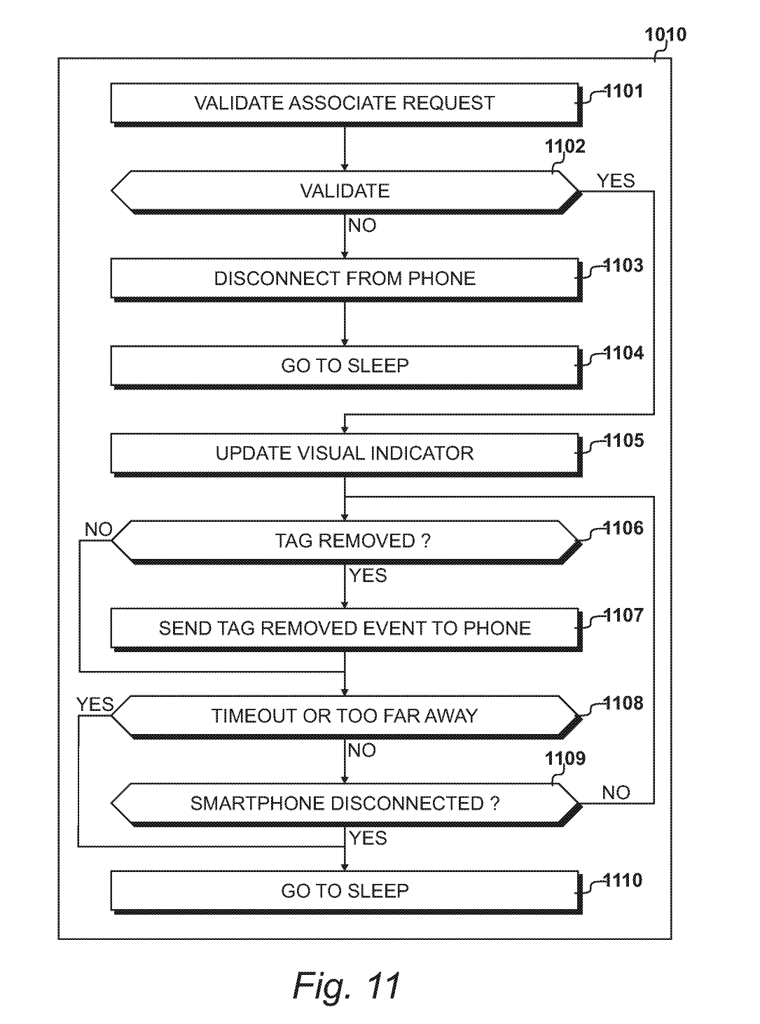

### FIG. 11

The step 1010 of associating the tag 113 with the smartphone 118, shown in FIG. 10, is detailed in FIG. 11. At step 1101 the association request received at step 1107 is validated. Validation includes receiving a digital signature from the smartphone 118 that authenticates an association. At step 1102 a question is asked as to whether validation has been successful. If not, the BLE connection to the smartphone 118 is broken at step 1103, and at step 1104 the microcontroller is returned to a low power sleep state.

Alternatively, in response to a successful validation, control is directed to step 1105, where the visual indicator 405 is updated to indicate the associated state by lighting the green LED 608. Subsequent steps 1106 to 1109 are repeated in a loop until various exit conditions occur. At step 1106 a question is asked as to whether the tag 113 has been removed from the physical item 101. This condition is detected by the conduction state of the retention pin 501. If the pin 501 is open circuit, the tag has been removed or an attempt has been made to remove it and control is directed to step 1107, where a tag removed event is transmitted to the smartphone 118. Alternatively, this step is skipped. At step 1109 a question is asked as to whether the smartphone has disconnected from the tag 113. If not, control is directed back to step 1106. Alternatively, the microcontroller 601 is returned to a low power sleep state at step 1110.

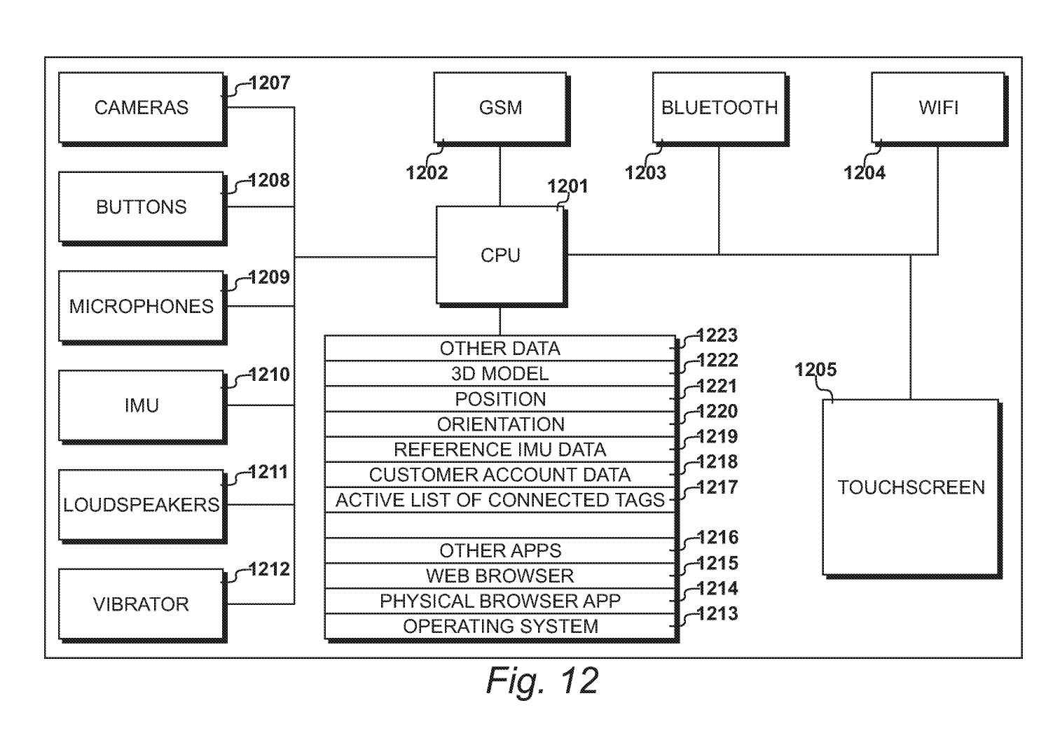

### FIG. 12

A schematic representation of the smartphone 118 shown in FIG. 1 is detailed in FIG. 12. A quad core 64-bit ARM Central Processor Unit (CPU) 1201 is connected with a GSM voice and data telephony module 1202. The CPU 1201 is further connected to a Bluetooth wireless module 1203, capable of communications in accordance with Bluetooth version 4.2, which includes Bluetooth Low Energy (BLE). A touchscreen 1205 provides the primary means by which the customer 106 interacts with the smartphone 118. The CPU 1201 is also connected to memory 1206, cameras 1207, buttons 1208, microphones 1209, an Inertial Measurement Unit (IMU) 1210, loudspeakers 1211 and a vibrator 1212.

For simplicity in the following explanation, the memory 1206, as before, is shown without distinction between volatile and non-volatile types. The memory 1206 includes instructions 1213 to 1216, including an Android™ operating system 1213, a physical browser app 1214, a web browser 1215 and other apps 1216. The instructions 1213 to 1216 are executed by the CPU 1201 in order to define the operations of the smartphone 118.

The memory 1206 also includes data 1217 to 1223, including an active list of connected tags 1217, customer account data 1218 relating to the customer 106, reference IMU data 1219, orientation 1220, position 1221. The orientation 1220 and the position 1221 are considered to be position-related parameters. A 3D model 1222 describes relative locations of second tags 113 to 117, and other data 1223 is used by the CPU 1201 to perform intermediate calculations.

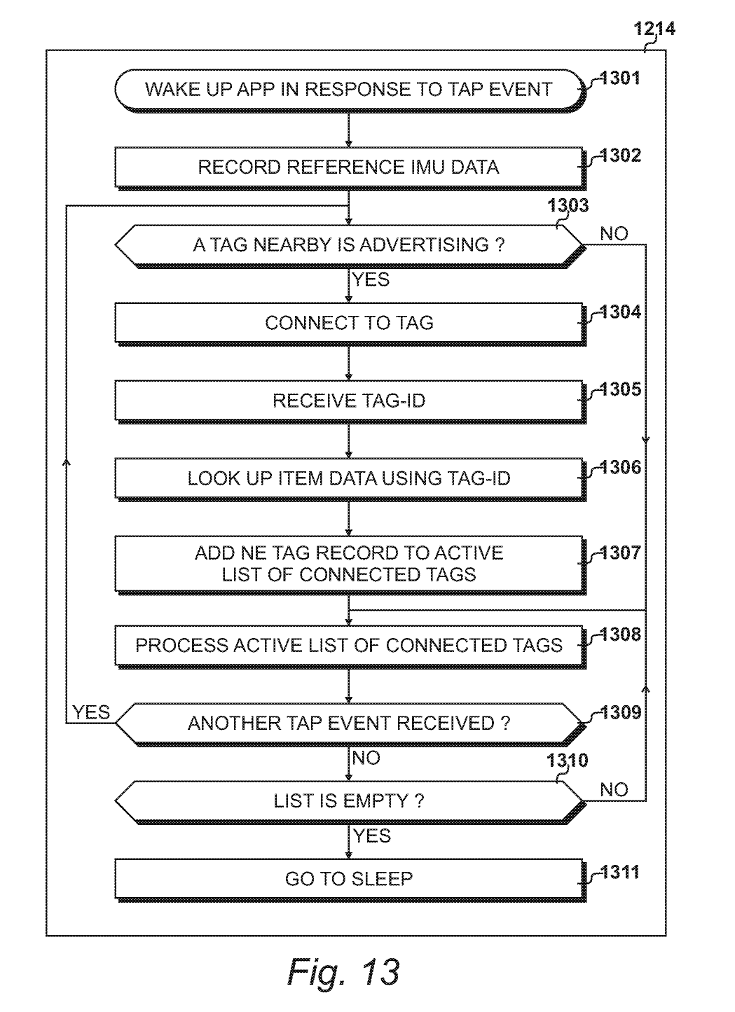

### FIG. 13

The physical browser app instructions 1214, shown in FIG. 12, are detailed in FIG. 13. During normal use of the smartphone 118, the physical browser app 1214 remains in memory 1206 without affecting other functions of the smartphone 118, such as making and receiving phone calls, browsing the Internet and running other apps 1216.

When the smartphone 118 is tapped against an object, such as the second tag 113, signals from its microphones 1209 and Inertial

Measurement Unit (IMU) 1210 are analysed to determine whether it is possible that the smartphone has been tapped against a tag. If such a possibility is judged to exist, the physical browser app 1214 is woken up at step 1301.

At step 1302, IMU data is obtained from the IMU 1210 and stored as reference IMU data 1219. At step 1303 a question is asked as to whether a nearby tag 113 is advertising. If not, steps 1304 to 1307 are skipped and control is directed to step 1308. Alternatively, if an advertising signal is detected from a tag 113, at step 1304 a BLE connection is made with the tag 113. At step 1305 the TAG_ID 805 is received from the tag 113. This may take the form of a Universally Unique Identifier or similar number unique to the second tag 113. In an embodiment, this may alternatively comprise or be derived from the EPC 303 of the first tag 108 retained within the item 101. In a further embodiment, step 1305 is unnecessary, because the TAG_ID 805 or its equivalent was transmitted as part of BLE advertising data, which has already been received by the smartphone 118.

At step 1306 the TAG_ID is used to look-up item data on the administration sever 126. The item data includes graphical and geometric data for drawing a representation of the item 101, price data for display to the customer 106 on the touchscreen 1205, availability data for other sizes and colours, and so on.

At step 1307 a new record is generated for the newly connected tag 113, which is then added to the active list of connected tags 1217. The new record includes the TAG_ID 805 along with the data obtained at step 1306.

At step 1308 the active list of connected tags 1217 is processed. During this step, it is possible for one or more tags to be removed from the list 1217. At step 1309 a question is asked as to whether another tap event has been identified from a background analysis of signals from the microphones 1209 and the IMU 1210. If so, control is directed back to step 1303, where the possibility of another tag-activation is considered. Alternatively, control is directed to step 1310 where a question is asked as to whether the active list of connected tags 1217 is empty. If not, control is directed back to step 1308, resulting in a loop in which the list 1217 is processed, and a check is made to see whether new tap events have been received, and whether the list 1217 has become empty. If no tags are present in the list 1217, control is directed to step 1311, where the app is put to sleep, for subsequent waking at step 1301 in response to another tap event.

The steps of FIG. 13 result in connection to one or more second tags 113 to 117, in response to a mutual impact between the second tag, such as tag 113, and a mobile device, such as the smartphone 118.

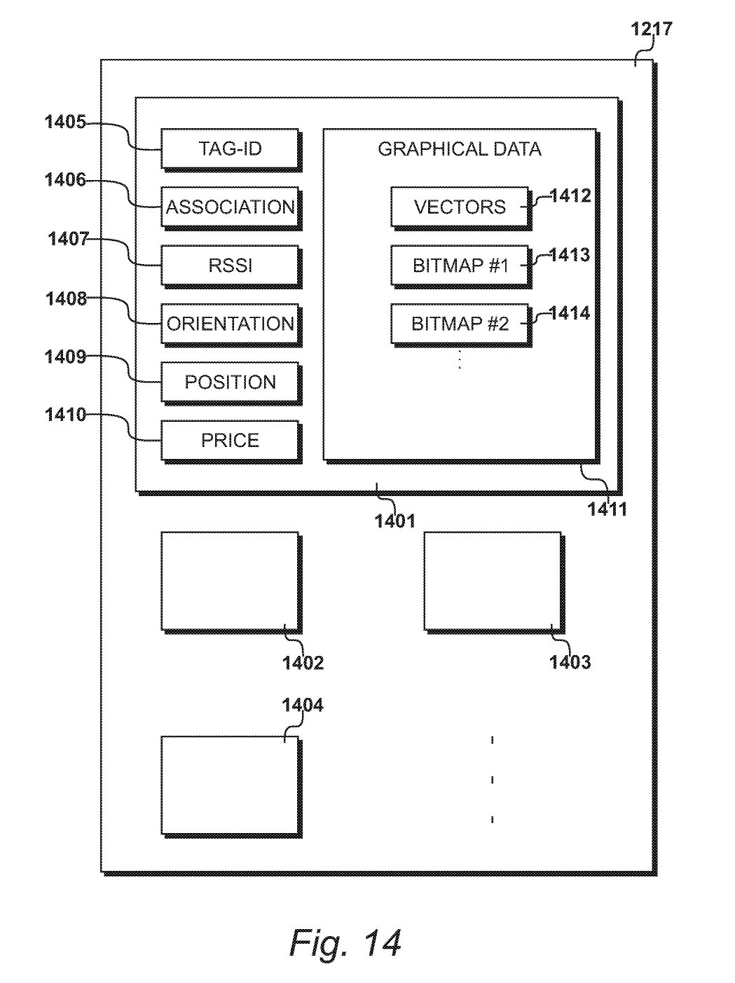

### FIG. 14

The active list 1217 of connected tags shown in FIG. 12 is detailed in FIG. 14. Each list item 1401, 1402, 1403 and 1404 is a record for a respective connected tag 113, 114, 115 and 116. Records may be added to or removed from the list dynamically, while the customer 106 physically browses items 101 to 105 in the retail environment. Record 1401 is for second tag 113, and includes a copy 1405 of the TAG_ID 805. The record 1401 further includes an association flag 1406, which is initially clear. This indicates whether the item 101 has been associated with the customer 106. The record 1401 also includes an RSSI field 1407, which is derived from RSSI values in both directions between the smartphone 118 and the tag 113. An orientation field 1408 and a position field 1409 are updated from tag movement data transmitted from the tag 113 at step 1003. Thus, the RSSI 1407, the orientation 1408 and the position 1409 are all considered to be position-related parameters.

A price field 1410 is updated from an enquiry made to the administration server 126 at step 1306 using the TAG_ID 805. In response to the request of step 1306, the administration server 126 also provides graphical data 1411, including vector data 1412 and bitmaps 1413, 1414. The graphical data makes it possible to draw an accurate visual representation of the item 101 on the touchscreen 1205 of the smartphone 118. Other records 1402, 1403 and 1404 include similar data for their respective items 102, 103 and 104.

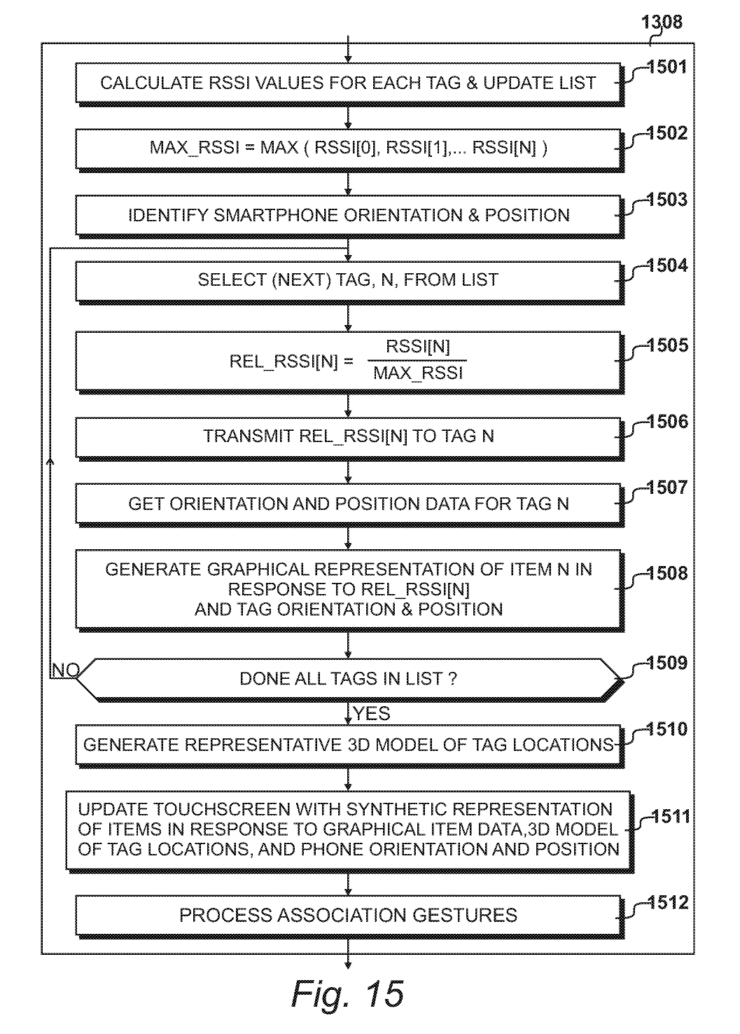

### FIG. 15

The step 1308 of processing the active list of connected tags, shown in FIG. 13, is detailed in FIG. 15. At step 1501 the RSSI value for each tag is calculated, and the relevant field 1407 is updated. This calculation takes the RSSI in both directions between a tag 113 and the smartphone 118 and takes the effective average. At step 1502 MAX_RSSI is calculated as being the largest of all the RSSI values calculated at step 1501. At step 1503 the orientation 1220 and position 1221 of the smartphone 118 are obtained. It is difficult to obtain the position of the smartphone 118 or any of the second tags 113 to 117 to a high degree of accuracy, so a low-pass filtered approximation or assumption is used.

At step 1504 the first of the second tag records 1401 to 1404 in the list 1217 is selected. At step 1505 the relative signal strength, REL_RSSI[N], for a tag is calculated, based on previously calculated values for RSSI[N] and MAX_RSSI. The REL_RSSI is considered as a position-related parameter, which may be used to update the visual indicators 405 of connected tags, and or affect display of items on the touchscreen 1205. At step 1506 REL_RSSI[N] is transmitted to its respective tag. This is received by the second tag 113 at step 1005 in FIG. 10. At step 1507 the orientation and position data for the currently selected tag are obtained. As with smartphone position, tag position is unlikely to be available to a high accuracy, and so this is generated based on some assumptions, and then heavily filtered. At step 1508 a graphical representation of the tagged item is generated in response to REL_RSSI[N] and the tag's orientation and position.

At step 1509 a question is asked as to whether all tag records in the list 1217 have been considered. If not, control is directed back to step 1504, and the next tag record is processed. Alternatively, control is directed to step 1510.

At step 1510 a representative 3D model 1222 of tag locations is generated. The representative model 1222 is partially or entirely arbitrary, depending upon the quality and availability of tag position data. Tag position data is primarily derived from RSSI, including REL_RSSI[N] calculated at step 1505. From the perspective of a customer 106 using their smartphone 118, what is required is an intuitive and clearly prioritized display of items 101 to 105; their relative locations do not have to be topographically correct. The 3D model 1222 generated at step 1510 is largely independent of the actual orientation and or position of the smartphone 118. Changes in orientation, position and RSSI are used to control changes in the 3D model 1222, as well as the intensity of the visual indicator 405 on each of the respective tags 113 to 117.

At step 1511 the touchscreen 1205 is updated with a synthetic representation of items 101 to 105 in response to respective graphical item data 1411, the 3D model 1222, and the orientation 1220 and position 1221 of the smartphone 118 identified earlier at step 1503. At step 1512 association gestures are processed. The steps of FIG. 15 are repeated several times a second, resulting in smooth animation of physical items 101 to 105 on the touchscreen 1205 as the customer rotates and moves the smartphone 118. However, the topographical arrangement of the items 101 to 105 is not physically accurate, and is deliberately distorted in order to prioritize the nearest item 101, and to facilitate easy display of additional information 1410 for that item 101. As the customer moves the smartphone 118 to another item 102 whose second tag 114 is activated, the touchscreen 1205 smoothly updates in response to smartphone movements, zooming in on the item 102.

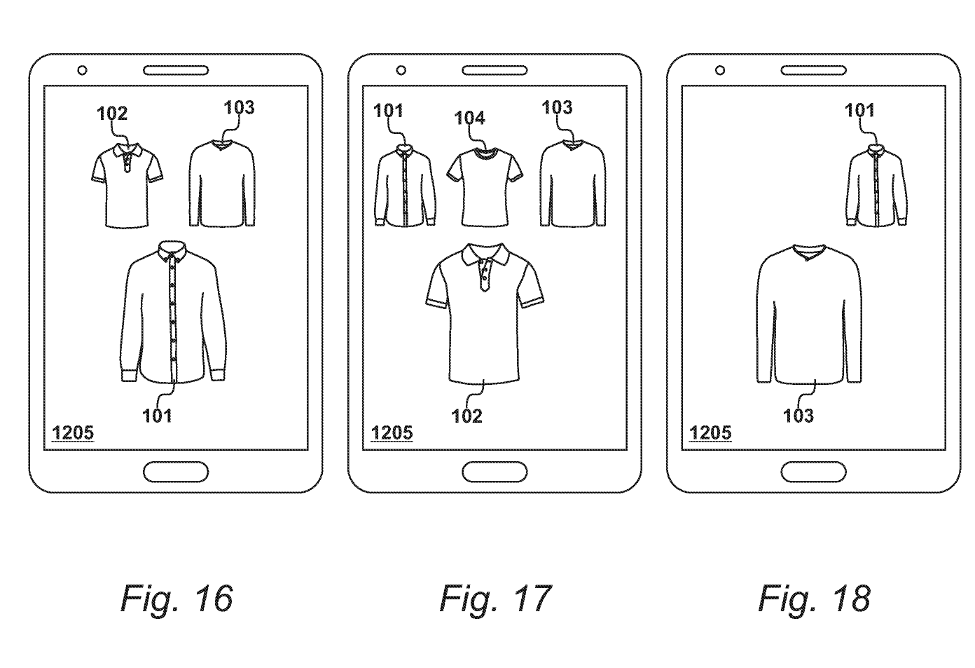

### FIG. 16

The effect of the steps of FIG. 15 is illustrated in FIG. 16. Having activated tags 113, 114 and 115, the customer 106 sees the touchscreen 1205 of the smartphone 118 showing the first item 101 in the foreground with the second item 102 and third item 103 in the background. The arrangement of the items 101, 102, 103 in the 3D representation on the display 1205 is not necessarily the same as that of the physical arrangement of the items in the retail environment. The smartphone 118 is closest to the first item 101, and so this is displayed most prominently.

### FIG. 17

A different view is shown in FIG. 17, where the customer has activated the fourth tag 116 but has subsequently moved their smartphone 118 nearer to the tag 118 of the second item 102. The second item 102 is in the foreground of the simulated 3D representation on the touchscreen 1205, and the three other items are displayed at a smaller size in the background.

### FIG. 18

A further view is shown in FIG. 18, where the customer has deactivated the second and fourth tags 114 and 116. The third item 103 is in the foreground of the simulated 3D representation on the touchscreen 1205, and the first item 101 is displayed in the background. It will be appreciated that the views shown in FIGS. 16 to 18 are updated continuously at a high frame rate, resulting in a smooth animation in real time, in response to movements and gestures of the smartphone 118.

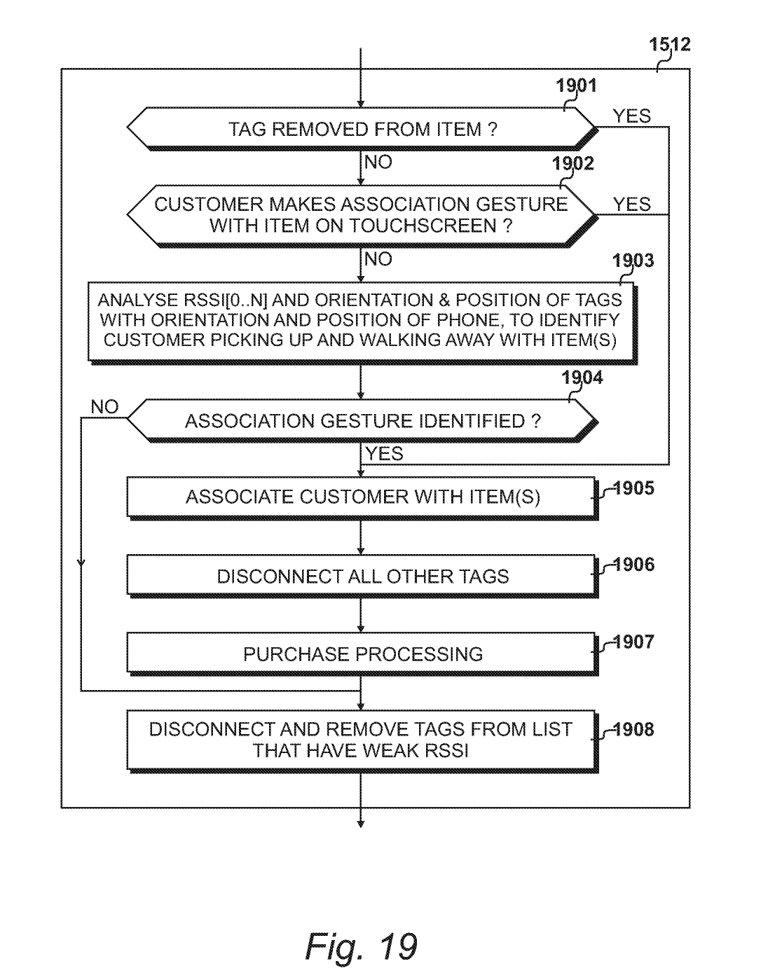

### FIG. 19

The step 1512 of processing association gestures, shown in FIG. 15, is detailed in FIG. 19. At step 1911 a question is asked as to whether the second tag 113 has been removed from the item 101. If so, this is considered as an association gesture made by the customer 106, showing that they wish to purchase the item 101. In this case, control is then directed to step 1905. Alternatively, control is directed to step 1902, where a question is asked as to whether the customer 106, who is the user of the smartphone 118, has made an association gesture with the item's graphical representation on the touchscreen 1205. If so, control is directed to step 1905.

Alternatively, control is directed to step 1903, where an analysis is made of the RSSI of each activated tag 113 to 116. This analysis is combined with tag orientation 1408 and position 1409 with respect to the smartphone orientation 1220 and position 1221 over a period of several seconds, thereby making it possible to identify a gesture of the customer 106 picking up the item 101 and walking away with it. In other words, the item 101 is moved from its original location beside other items 102 to 105. The analysis 1903 includes gait analysis in combination with orientation and movement analysis. The analysis may be performed with limited information. For example, if the tag 113 doesn't have an IMU, the proximity of the tag 113 to the smartphone 118 may be estimated from the RSSI 1407. The smartphone includes an IMU 1210, and can perform gait analysis. If footsteps or similar movement patterns are detected while the RSSI of one tag 113 remains high and the RSSI of other tags diminishes, this is interpreted at step 1903 as a picking up and walking away gesture for the item 101.

At step 1904 a question is asked as to whether an association gesture was identified. If not, control is directed to step 1908. Alternatively, control is directed to step 1906, where BLE connections with all other activated tags 114 to 116 are disconnected. At step 1907 purchase processing is performed. At step 1908, activated second tags 113 to 116 that have consistently weak signal strengths are disconnected and removed from the active list of connected tags 1217.

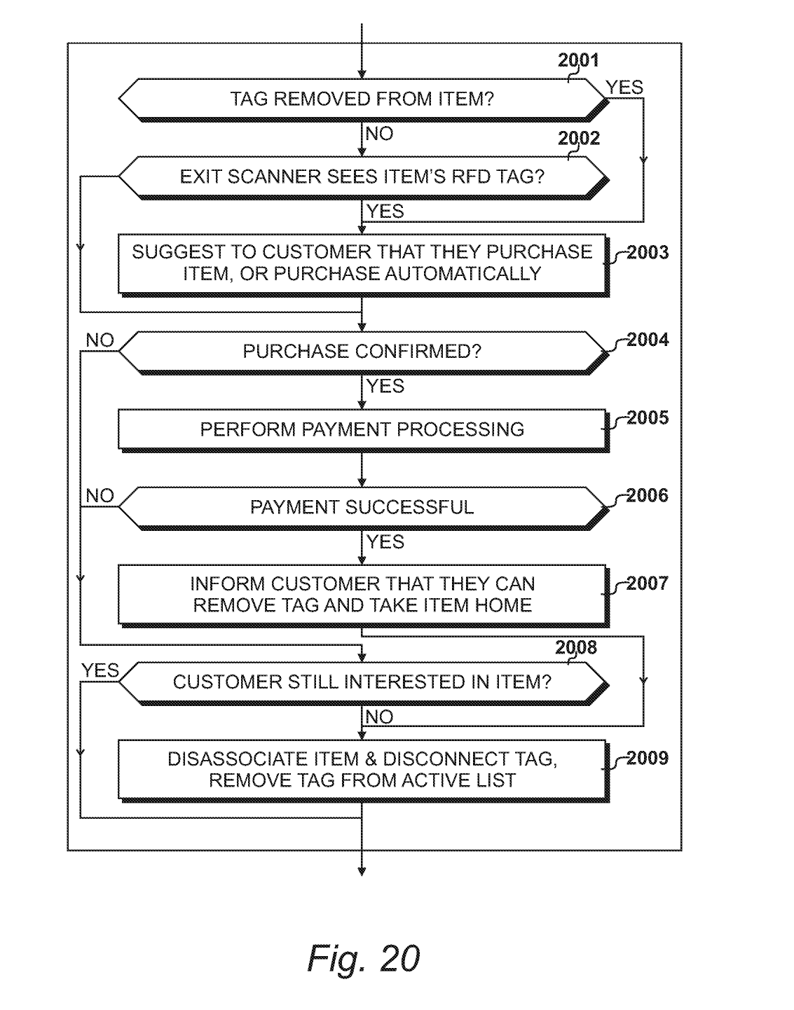

### FIG. 20

The step 1907 of purchase processing, shown in FIG. 19, is detailed in FIG. 20. At step 2001 a question is asked as to whether the second tag 113 has been removed from the associated item. If so, control is directed to step 2002. Alternatively, at step 2002 a question is asked as to whether an exit scanner 120, 121 has seen the item's first tag 108. This information is obtained by a communication between the smartphone 118 and the administration server 126, which communicates with the security server 119 in order to determine when a first tag 108 to 112 has been identified near one of the exit scanners 120, 121.

If an exit scanner has not detected the first tag 108, control is directed to step 2004. Alternatively, at step 2003 a suggestion is made to the customer 106, via the touchscreen 1205, that they purchase the item 101. Depending upon customer preferences for the physical browsing app 1214, the decision to make a purchase may be made and confirmed automatically as a result of an association 1905. At step 2004 a question is asked as to whether the purchase has been confirmed. If not, control is directed to step 2008.

At step 2005 payment for the item 101 is processed using a connection between the smartphone 118 and the payments server 127. As a result of this payment, the administration server 126 will be informed, securely, that the item 101 has been purchased by the customer 106.

At step 2006 a question is asked as to whether payment has been successful. If not, control is directed to step 2008. Alternatively, at step 2007, the customer is informed that they can remove the second tag 113 and take the item home. If the second tag has already been removed from the item, step 2007 is simplified to a confirmation of purchase of the item 101 being displayed on the smartphone's touchscreen 1205. Furthermore, a digital receipt of purchase is issued to the customer, to the customer's mobile device and by email.

If a purchase has not been made, a question is asked at step 2008 as to whether the customer 106 is still interested in the item 101. This can be answered by analysing RSSI, orientation and position information for the tag 113 and the smartphone 118. If the tag is some distance away from the phone, and is in a static position, it is decided that the customer is no longer interested in the item and control is directed to step 2009. Alternatively no further action is taken, in case the customer 106 decides subsequently to purchase the item 101. At step 2009, the item 101 and the customer 106 are disassociated, the tag 113 is disconnected, and the tag's record 1401 is removed from the active list of connected tags 1217.

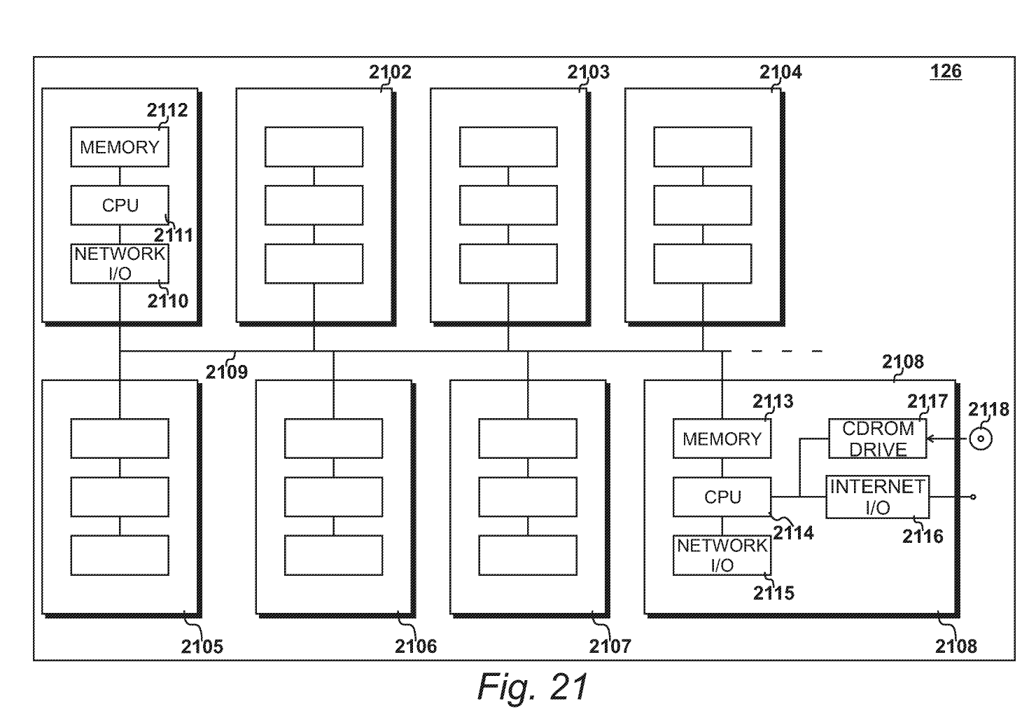

### FIG. 21

The administration server 126 shown in FIG. 1 is detailed in FIG. 21. The server 126 comprises a number of server units 2101 to 2108 connected to a Local Area Network (LAN) 2109. Server unit 2101 comprises a network I/O circuit 2110, facilitating network communications with a Central Processing Unit (CPU) 2111, which is connected to memory 2112. The memory comprises non-volatile FLASH and volatile RAM components, and will be treated as unified for the purposes of this description. Server units 2102 to 2107 have an identical construction to the first server unit 2101.

Server unit 2108 is a routing server, comprising a network I/O circuit 2113, a CPU 2114 and memory 2115. It further comprises a CDROM drive 2117 in which a CDROM 2118 can be placed to install instructions in the memory 2115, from where the instructions will be copied onto the memories of the other server units 2101 to 2107. A direct high bandwidth connection to the Internet 125 is facilitated by an Internet I/O circuit 2116, thereby providing connection between all the server units 2101 to 2108 to other devices attached to the Internet 125, including customer smartphones 118 and 119, the payments server 127 and the security server 119. The routing server 2108 receives incoming HTTP requests from the Internet 125, and routes these requests to the remaining server units 2101 to 2107, in such a way as to balance the request and processing load evenly across the servers. In this way, the administration server units 2101 to 2108 provide a load-balanced high capacity administration system 126 capable of handling thousands of simultaneous customer interactions.

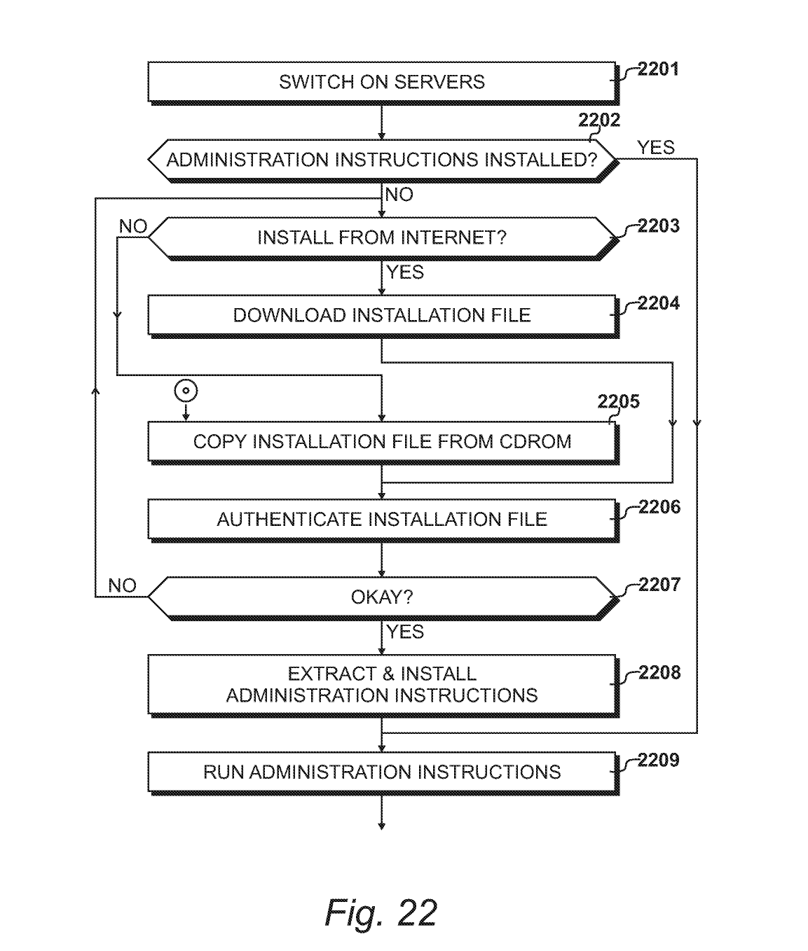

### FIG. 22

Operation of the administration server 126, shown in FIG. 21, is detailed in FIG. 22. At step 2201 the server units 2101 to 2108 are switched on. At step 2202 a question is asked as to whether administration instructions have been installed. If so, control is directed to step 2209, and the administration instructions are run. Alternatively, control is directed to step 2203, where a question is asked as to whether the instructions should be installed via the Internet 125. If so, control is directed to step 2204, where an installation file is downloaded, and control is directed to step 2206. Alternatively, control is directed to step 2204, where an installation file is read from the CDROM 2118. At step 2206, the installation file is authenticated.

At step 2207 a question is asked as to whether the authentication performed at step 2206 was successful. If not, control is directed back to step 2203 so that a new installation file can be obtained. Having successfully authenticated the installation file, administration instructions are installed at step 2208 by a process of multiple file extraction from the installation file. The extracted instructions are copied onto the routing server memory 2115, and from there are copied to the memory 2112 of the first server unit 2101, and the memories of the other server units 2102 to 2107. At step 2209 the installed administration instructions are executed by all of the servers 2101 to 2108, effectively in parallel.

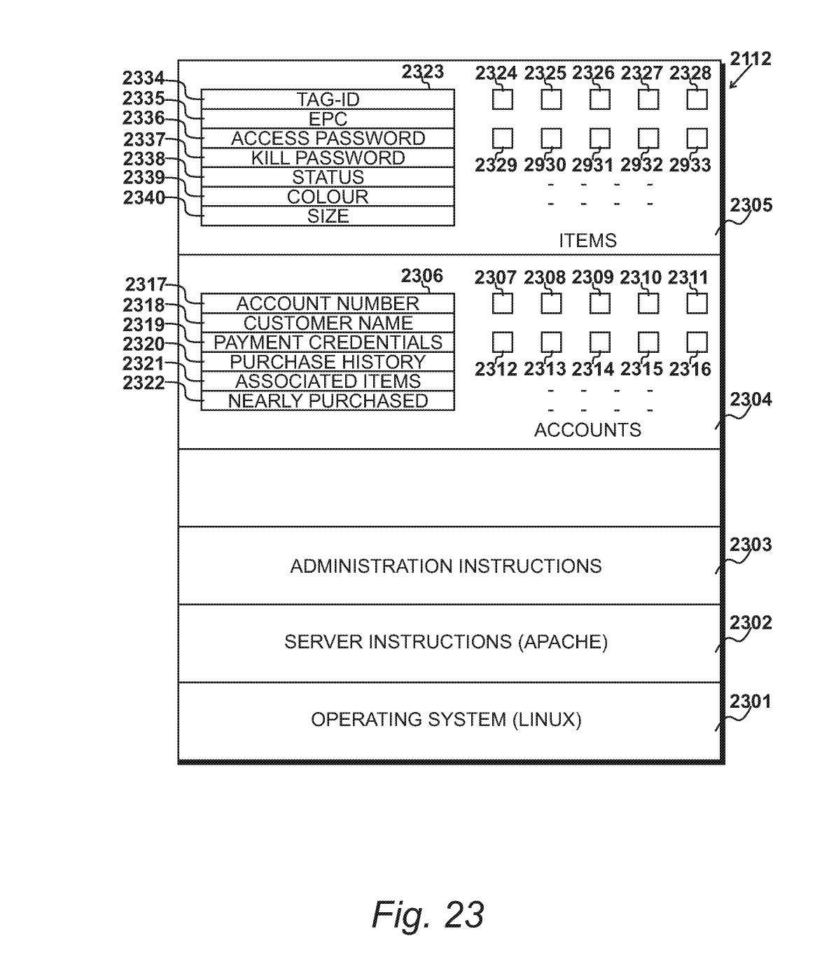

### FIG. 23

The contents of the memory 2112 of the first server unit 2101 shown in FIG. 21, during the running of administration instructions 2209, are shown in FIG. 23. A Linux™ Operating System (OS) 2301 provides hardware abstraction, task management, and other common utilities. Apache™ Server instructions 2302 handle HTTP requests forwarded from the routing server 2108. Administration instructions 2303 define the operation of the servers. Customer account data 2304 stores account data for customers wishing to perform physical browsing with their smartphones 117 and 118 or other mobile devices. Item data 2306 stores data for all of the individual items tagged, in one or more retail environments.

The customer account data 2304 includes individual customer accounts 2306 to 2316. Each account includes an account number 2317, a customer name 2318, payment credentials 2319, purchase history 2320, associated items 2321 and nearly purchased items 2322. Nearly purchased items are identified as those whose second tags 114 to 117 have been activated, but which were subsequently not purchased.

The item data 2305 includes individual item records 2323 to 2333. Each item record 2323 to 2333 corresponds to a particular physical item in a retail environment. The item record 2323 corresponds to physical item 101, item record 2324 corresponds to the physical item 102, and so on.

The record 2323 for the first item 101 includes a copy 2334 of the TAG_ID 805 that is also stored in the memory 603 of the second tag 113. Also included is the item's EPC 2335, which is stored 303 in the memory of the first tag 108. Further item data includes a copy 2336 of the access password 305 and a copy 2337 of the kill password 306 of the first tag 108. A status field 2338 determines whether an item 101 is currently associated with a customer, how many customers have associated with this item, whether it has been purchased, and so on. Descriptive data including colour 2339 and size 2340 are also stored.

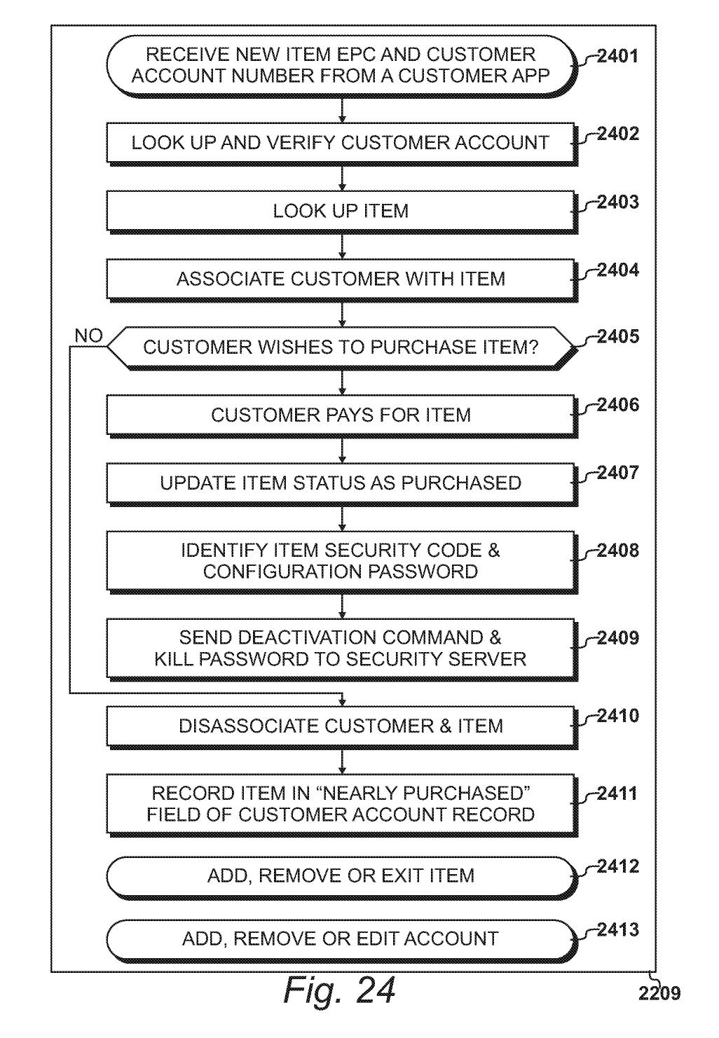

### FIG. 24

The step 2209 of running administration instructions, shown in FIG. 22, is detailed in FIG. 24. At step 2401 data is received in the form of a request from a customer's physical browsing app 1214 running on the smartphone 118. The data specifies the TAG_ID 805 of the second tag 113 and the customer's account number 2317.

At step 2402 the customer's account 2306 is looked-up and verified. At step 2403 the item's record 2323 is looked up using the TAG_ID 805 as an index. At step 2404 the customer 106 is associated with the item 101. At step 2405 a question is asked as to whether the customer wishes to purchase the item. The answer to this question is provided by the physical browsing app 1214 running on the customer's smartphone 118 in accordance with the steps detailed in FIG. 20.

If the customer does not wish to purchase the item, control is directed to step 2410. Alternatively, control is directed to step 2406 where payment by the customer is established and confirmed, by initiating secure communications between the admin server 127 and the customer's smartphone 118 and waiting for a cryptographic confirmation that payment has been made.

At step 2407 the item's status 2338 is updated as purchased. At step 2408 the item's EPC 2335 and kill password 2337 are identified. At step 2409 a deactivation command for the first tag 108 is transmitted to the security server 119. The deactivation command includes the first tag's EPC 303, so that, when the item's RFID tag 108 comes near a scanner 120 to 123, the tag 108 will be recognised but the alarm 124 will not be set off. Data transmitted in step 2409 includes the kill password 2337, which will subsequently be transmitted by a scanner 120 to 123 to the tag 108 after detection, in order to permanently disable it. This prevents the tag 108 from being scanned and detected in future.

If the customer does not wish to purchase the item 101, at step 2410 the customer and the item are disassociated by updating the status field 2338. At step 2411 the item is recorded as having been nearly purchased by updating the nearly purchased field 2324 of the customer's account 2306.

Separate event-driven processes 2412 and 2413 facilitate maintenance of the data structures of the administration server 126. Process 2412 allows administration staff to add, remove or edit items from the item records 2305. Process 2413 enables customer records to be added, removed or edited, via an interface provided in the customer's physical browsing app 1214.

It will be appreciated that writing to an item 2323 in memory 2112 results in updates to other instances of the same cached data structure on other server units 2102 to 2108 in the administration server 126. Those skilled in the art will be able to implement a coherent shared database of this kind by known methods.

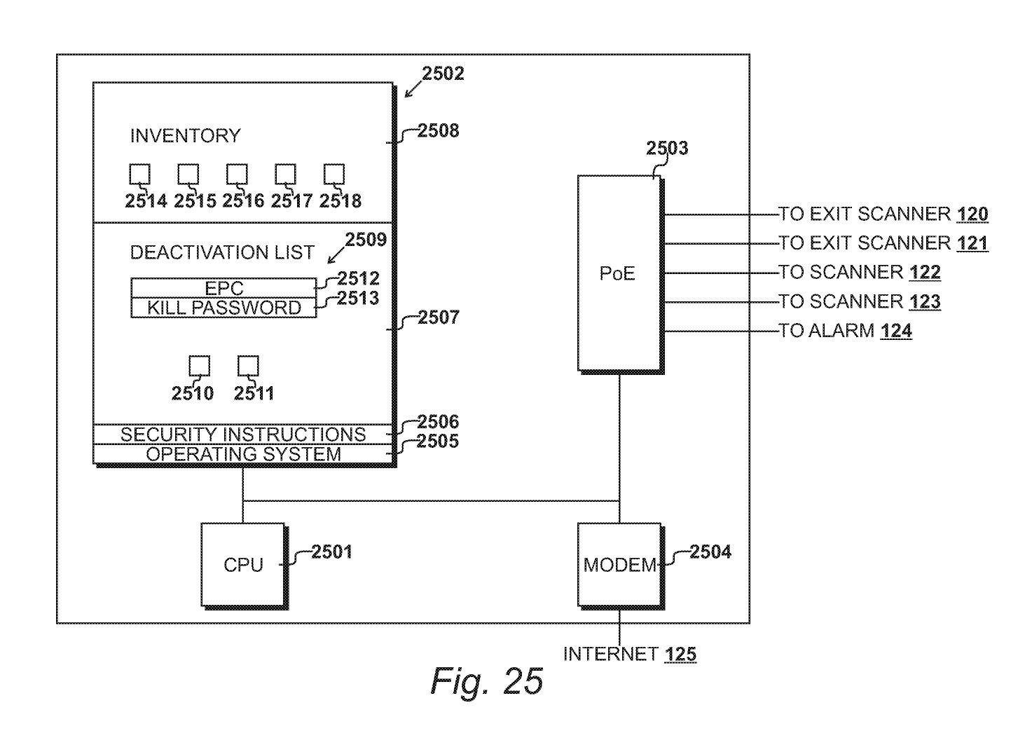

### FIG. 25

The security server 119 shown in FIG. 1 is detailed in FIG. 25. The security server 119 comprises a CPU 2501, volatile and non-volatile memory 2502, a Power over Ethernet (PoE) interface 2503 and a modem 2504. The PoE interface provides connections and power to the RFID scanners 120 to 123, and the alarm 124. The modem 2504 provides Internet connectivity.

The memory 2502 includes Linux operating system instructions 2505 and security instructions 2506. Data in the memory 2502 includes a deactivation list 2507 and an inventory 2508. The deactivation list 2507 includes records 2509, 2510 and 2511 for items which have been purchased and whose first tags 108, 109, 110 have not yet been deactivated. Each item in the deactivation list includes an EPC 2512 which is a copy of a first tag's EPC 303, and a copy 2513 of its kill password 306. Other data may also be included, such as the access password 305. The inventory 2508 includes records 2514 to 2518 for all the items 101 to 105 in the retail environment. Each inventory record 2514 to 2518 includes the same data 2512, 2513 as a record in the deactivation list 2507.

In an embodiment, the deactivation list 2507 is cached locally at each scanner 120 to 123, so that high speed interaction and decision making can occur during the short time when a tag 108 is activated. For the purposes of clarity, the following description will describe the relevant functionality as if implemented on the security server 127.

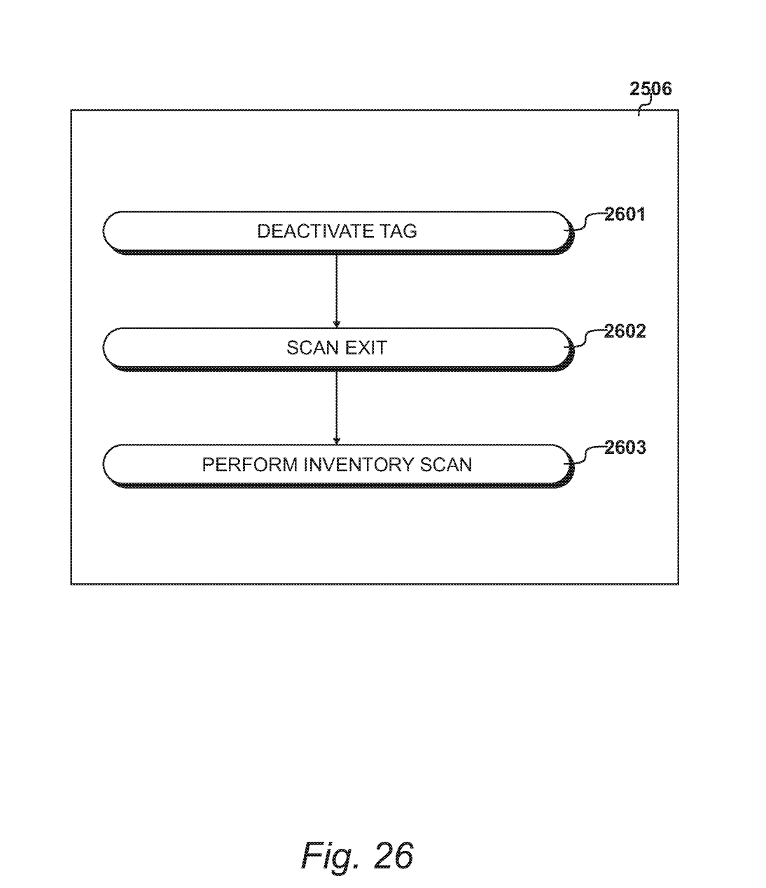

### FIG. 26

The security instructions 2506 shown in FIG. 25 are summarised in FIG. 26. Three parallel processes are shown. These include an event-driven deactivate tag process 2601, a continuous scan exit process 2602 and a continuous inventory scan process 2603.

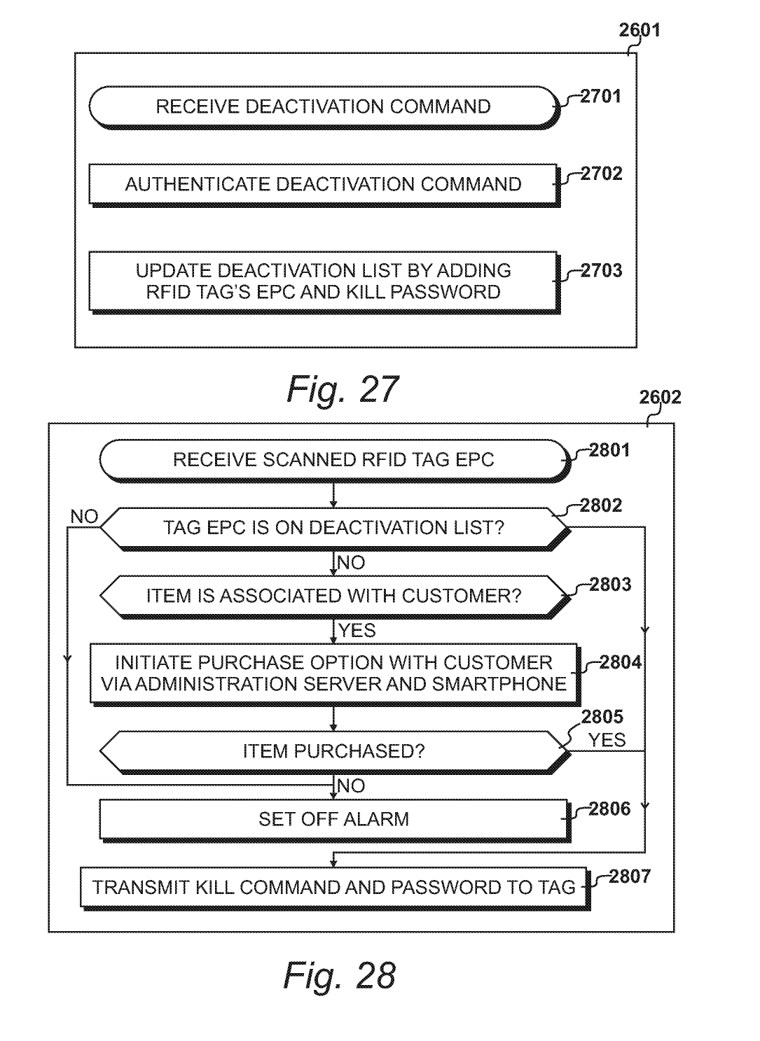

### FIG. 27

The deactivate tag event-driven process 2601, shown in FIG. 26, is detailed in FIG. 27. At step 2701 a deactivation command is received by the security server 119 from the administration server 126. At step 2702 the deactivation command is authenticated, to ensure that it has been sent by administration server 126. At step 2703 the deactivation list 2507 is updated by adding a record 2509 containing an RFID tag's EPC 303 and kill password 306.

### FIG. 28

The continuous scan exit process 2602, shown in FIG. 26, is detailed in FIG. 28. At step 2801 the security server 119 receives a scanned RFID tag's EPC 303 from one of the exit scanners 120, 121. At step 2802 a question is asked as to whether a record containing the EPC is on the deactivation list 2507. If so, control is directed to final step 2807 at which a kill command and password 2513 are transmitted back to the scanner nearest to the tag, thereby disabling the first tag 108 permanently. Alternatively, if the tag is not in the list 2507, control is directed to step 2803, where a question is asked via the administration server 126 as to whether the tagged item 101 is associated with a customer 106. If so, communications are sent to the administration server at step 2804 to initiate a request for the customer to purchase the item, or possibly to return the item, if it is not of interest.

At step 2805 a question is asked as to whether the item has now been purchased. If not, the alarm 124 is set off. Similarly, if the item was found not to be associated with a customer at step 2803, control is directed to step 2806, where the alarm 124 is set off.

Furthermore, if the item was successfully purchased at step 2804, or the tag was already on the deactivation list as previously mentioned, control is directed to step 2807 which causes the tag to be deactivated. Deactivation of the tag has the desired effect of deactivating the alarm 124 so that the customer 106 can exit the retail environment with the purchased item 101, without the alarm 124 going off.

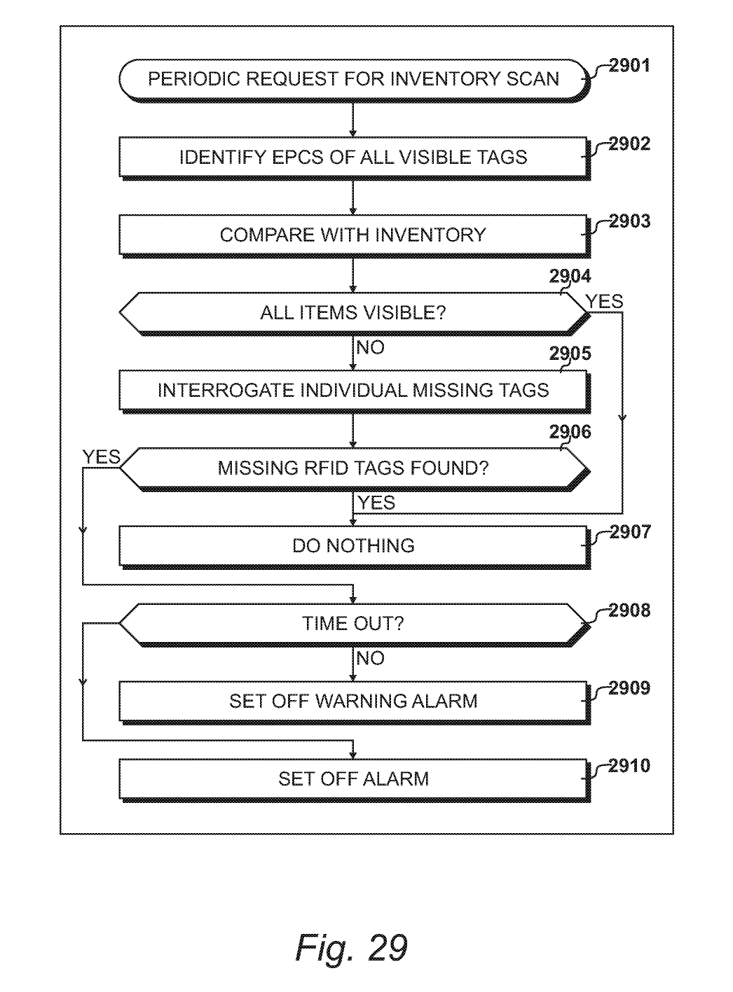

### FIG. 29

The continuous inventory scan process 2603 shown in FIG. 26 is detailed in FIG. 29. At step 2901 a periodic request for an inventory scan is made. At step 2902 the EPCs of all visible RFID tags 108 to 112 are identified using scanners 120 to 121. At step 2903 the visible RFID tags are compared with the inventory 2508. At step 2904 a question is asked as to whether all items in the inventory are visible. If not, control is directed to step 2905, where missing tags are interrogated individually to see if they can be found. If the missing tags are found, control is directed to step 2907, where nothing further is done, because the inventory 2508 matches the visible tags.

Alternatively, if some RFID tags remain missing, control is directed to step 2908 where a timeout is tested. If the timeout is less than ten seconds, control is directed to step 2909, where a silent warning alarm is provided to staff in the retail environment, by transmitting a text message to their mobile devices, or by some other convenient silent process. Alternatively, if one or more RFID tags has gone missing for a sustained period of time, the main alarm 124 is set off at step 2910.

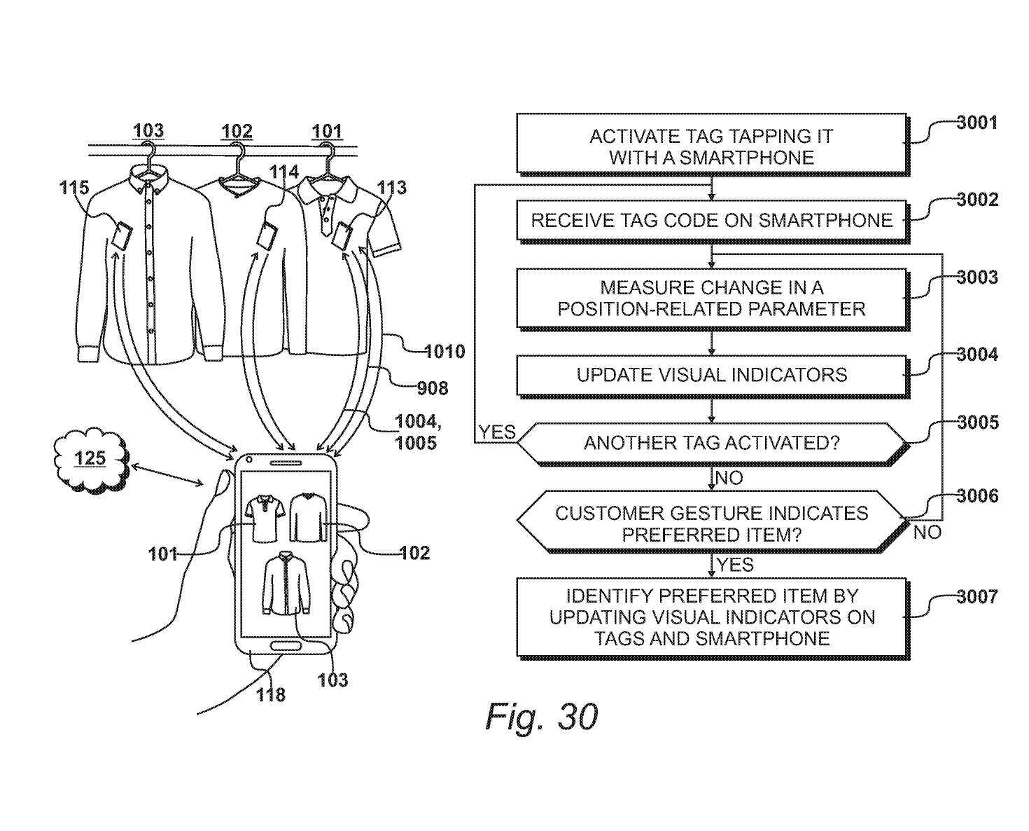

### FIG. 30

The actions performed with respect to the retail environment of FIG. 1 and following Figures are summarised in FIG. 30. Initially the second tags 113, 114 and 115 are deactivated. At step 3001 a tag 113 is activated in response to a customer interaction in the form of a physical gesture where the customer's mobile device 118 is tapped lightly against the tag 113. The energy of this impact is translated into electrical energy by the piezo transducer 611, thereby activating the tag 113 by waking up it's microcontroller 601.

At step 3002 the TAG_ID is received on the smartphone 118 as a unique tag code identifying the tag, enabling the phone to obtain information about the tagged item 101 from the administration server 126 via the Internet 125. At step 3003 a change in a position-related parameter, based on RSSI, is measured. This measurement of change is implicit, since the normalisation calculation shown at step 1505 in FIG. 15 has the effect of causing visual indicator updates to occur in response to change, rather than absolute values. In an embodiment, measurements of change are obtained by an explicit calculation of a change in a position-related parameter over time. For example, this may be achieved by subtracting samples of a position-related parameter from one or more previous values.

At step 3004 visual indicators are updated in response to the measured change. The visual indicators updated include the visual indicator 405 on each of the activated second tags 113, 114, 115. The touchscreen 1205 on the customer's mobile device 118 also facilitates a visual indicator that is updated. In an embodiment, either the tag visual indicator 405 or the touchscreen visual indicator is not updated, or is not physically provided. At step 3005 a question is asked as to whether another tag 114 or 115 has been activated. If so, control is directed back to step 3002. Alternatively, control is directed to step to step 3006, where a question is asked as to whether the customer 106 has made a gesture indicating a preferred item. A preferred item is indicated by the customer by making one of the association gestures described with reference to FIG. 19 and FIG. 20. One type of association gesture is to pick up the item 101 and take it away from the vicinity of the other tagged items 102 and 103. If no preference is indicated, control is directed back to step 3003.

Steps 3003 to 3006 form a loop which repeats several times a second, updating visual indicators 405 on the second tags 113, 114 and 115, once those tags have been activated. Also updated are areas of the touchscreen 1205 on the customer's mobile device 118. By performing these repeated updates, the customer 106 is able to immediately see the effect of movements of their mobile device 118 with respect to the locations of tags 113 to 115 on the items 101 to 103. Visual indications from the tags 113 to 115 as well as the touchscreen 1205 provide an intuitive feedback mechanism for physical browsing of items.

During physical browsing, items 101 to 103 displayed on the mobile device 118 change in size, to further improve the feeling of physical interaction. The item 101 nearest the mobile device 118 may be displayed with additional information, such as price and availability of colours and sizes. As the customer moves the mobile device 118 closer to another item 102, the display of such additional information is modified and updated with information for the second item 102. This provides the customer 106 with an intuitive way of obtaining detailed information about multiple items.

At step 3007, a preferred item is identified by changing the visual indicators 405 on the tags 113 to 115 appropriately. The preferred item's tag is then indicated by a bright white colour, and the other tags are deactivated to save power. Also, the touchscreen 1205 of the mobile device 118 is updated to show that the preferred item 101 has been selected. This identification of a preferred item by an association gesture may result in an immediate payment for the item, if automated purchase has been selected as an option by the customer 106.

The invention claimed is:

1. A security system for deployment within a retail environment, comprising:
a plurality of first tags, wherein each said first tag is concealed within an item of merchandise and is configured to transmit a first signal modulated to specify a first tag code in response to being energized at an exit gate;
a plurality of second tags, wherein each said second tag is independently attached to a said item of merchandise and is configured to communicate with mobile devices to facilitate a purchase of a said item via said mobile device; and
a data communication apparatus for communicating with said mobile devices and controlling responses of said exit gate when detecting output signals from said first tags, wherein:
a user selected second tag transmits a second output signal modulated by a unique second code to a mobile device in response to a user interaction;
said mobile device relays a received second code to said data communication apparatus;
said data communication apparatus initiates a procedure to facilitate a purchase of an item to which an interacted second tag is attached, resulting in a sale being completed or a sale failing to be made, such that:
said data communication apparatus controls said exit gate so as not to raise an alarm upon detecting a respective first tag concealed within a purchased item; and
said exit gate raises an alarm in response to first concealed tags when respective second tags attached to the same item have not completed a sale.

2. The system of claim 1, wherein said first tags includes a radio frequency identification (RFID) device.

3. The system of claim 2, wherein said communication apparatus controls said exit gate in order to de-active first tags concealed in items that have been purchased.

4. The system of claim 1, wherein said second tags communicate with mobile devices using a Bluetooth protocol.

5. The system of claim 1, wherein a user selection is made by a physical interaction with a second tag.

6. The system of claim 1, wherein each said second tag includes an indicator, wherein said indicator is activated after an item to which said tag is attached has been purchased, thereby inviting a user to physically remove the attached second tag.

7. The system of claim 5, wherein said second tag includes an impact detector for generating an activation signal in response to an impact between said second tag and a mobile device.

8. The system of claim 1, wherein said second tag includes a removal detection device.

9. A security system for deployment within a retail environment, comprising:
a plurality of first tags, wherein each said first tag is concealed within an item of merchandise for detection at an exit gate;
a plurality of second tags, wherein each said second tag is independently attached to said item and is configured to communicate with mobile devices to facilitate a purchase of a said item via said mobile device; and
a data communication apparatus for communicating with mobile devices and controlling responses of said exit gate when detecting output signals from said first tags, wherein:
a plurality of user selected second tags transmit second output signals to a mobile device in response to respective user interactions, wherein each said second output signal is modulated by a unique tag code;
said mobile device relays said received second codes to said data communication system;
said data communication system returns product data for said plurality of selected second tags, wherein said product data includes a graphical representation of each selected item;
said mobile device is configured to dynamically display each said graphical representation of selected items;
said mobile device is configured to dynamically position said graphical representations in response to positional data identifying a relative position of each said selected item with respect to the mobile device; and
said mobile device is configured to further communicate with said communication system to initiate a sale of a preferred item chosen from said displayed selected items.

10. The system of claim 9, wherein said positional data is derived from an evaluation of relative signal strengths of respective second output signals.

11. The system of claim 9, wherein said positional data is derived from an evaluation of orientation data derived from devices resident within the mobile device.

12. The system of claim 11, wherein said devices resident within the mobile device include accelerometers.

13. The system of claim 11, wherein a preferred item is selected by impacting a mobile device upon the second tag attached to the preferred item.

14. The system of claim 11, wherein a preferred item is chosen by receiving input commands to remove graphical representations of other non-chosen selected items.

15. The system of claim 11, wherein a preferred item is chosen by moving the selected item with the mobile device away from the non-chosen selected items.

16. A security system for deployment within a retail environment, comprising:
a plurality of first tags, wherein each said first tag is concealed within an item of merchandise and is configured to transmit a first signal modulated to specify a unique first tag code in response to being energized at an exit gate;
a plurality of second tags, wherein each said second tag is independently attached to a said item of merchandise and is configured to communicate with mobile devices to facilitate the purchase of a said items via said mobile device; and
a data communication apparatus for communicating with said mobile devices and controlling responses of said exit gate when detecting output signals from said first tags, wherein:
a plurality of user selected second tags transmit second output signals to a mobile device in response to respective user interactions, wherein each said second output signal is modulated by a unique second code;
said mobile device relays said received second codes to said data communication system;
said data communication system returns product data for said plurality of selected second tags, wherein said product data includes a graphical representation of each selected item;
said mobile device is configured to dynamically display each said graphical representation of selected items;
said mobile device is configured to dynamically position said graphical representations in response to positional data identifying a relative position of each said selected item to the mobile device;
said mobile device is configured to further communicate with said communication system to initiate a sale of a preferred item chosen from said displayed selected items; and
said data communication apparatus controls said exit gate so as not to raise an alarm in responsive to identifying a respective first tag concealed within a purchased item.

17. The system of claim 16, wherein said communication apparatus controls said exit gate in order to de-activate first tags concealed in items that have been purchased.

18. The system of claim 16, wherein said positional data is derived from an evaluation of relative signal strengths of respective second output signals.

19. The system of claim 16, wherein a preferred item is selected by impacting a mobile device upon the second tag attached to the preferred item.

20. The system of claim 16, wherein a preferred item is chosen by moving a selected item with the mobile device away from the non-chosen selected items.
